(19) United States
(12) Patent Application Publication
(10) Pub. No.: US 2026/0197896 A1
(43) Pub. Date: Jul. 9, 2026

(54) FAST SECONDARY CELL ACTIVATION

(71) Applicant: QUALCOMM Incorporated, San Diego, CA (US)

(72) Inventors: Kianoush HOSSEINI, San Diego, CA (US); Changhwan PARK, San Diego, CA (US); Heechoon LEE, San Diego, CA (US)

(21) Appl. No.: 19/442,851

(22) Filed: Jan. 7, 2026

Related U.S. Application Data
(60) Provisional application No. 63/743,130, filed on Jan. 8, 2025.

(51) Int. Cl. H04W 76/20; H04W 56/00; H04W 72/21; H04W 72/51; H04W 80/02

(52) U.S. Cl. CPC H04W 76/20; H04W 56/0045; H04W 72/21; H04W 72/51; H04W 80/02

(57) ABSTRACT

Methods, systems, and devices for wireless communication are described. A network entity (e.g., a user equipment (UE)), receives activation information indicating a plurality of secondary cells that are activated or are to be activated, wherein the activation information is configured to cause the network entity to transition to a ready state; transmits readiness information associated with the ready state for one or more operations in at least one secondary cell of the plurality of secondary cells; and performs, in accordance with the readiness information, the one or more operations in the at least one secondary cell. The network entity performs, in accordance with one of the first or the second indication, the one or more operations in a first secondary cell of the at least one secondary cell while the network entity is in the ready state.

### CROSS REFERENCES

The present Application for Patent claims benefit of U.S. Provisional Ser. No. 63/743,130 by HOSSEINI et al., entitled “FAST SECONDARY CELL ACTIVATION,” filed Jan. 8, 2025, and assigned to the assignee hereof. U.S. Provisional Ser. No. 63/743,130 is expressly incorporated herein in its entirety.

### INTRODUCTION

The following relates to wireless communication, including fast secondary cell activation.

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method of wireless communication performed by a network entity is described. The method includes receiving activation information that indicates a plurality of secondary cells. The activation information causes the network entity to transition to a ready state. The method further includes transmitting readiness information that includes one of a first indication that the network entity is in the ready state for one or more operations in at least one secondary cell of the plurality of secondary cells or a second indication of a time duration after which the network entity will be in the ready state for the one or more operations in the at least one secondary cell of the plurality of secondary cells. The first indication includes a set of bits indicating whether the network entity is in the ready state for the one or more operations in one or more secondary cells, including the at least one secondary cell, of the plurality of secondary cells. the time duration is with respect to a timing of the activation information. The method further includes performing, in accordance with one of the first indication or the second indication, the one or more operations in a first secondary cell of the at least one secondary cell while the network entity is in the ready state.

A network entity for wireless communication is described. The network entity comprises a processing system configured to receive activation information that indicates a plurality of secondary cells. The activation information causes the network entity to transition to a ready state. The processing system is further configured to transmit readiness information that includes one of a first indication that the network entity is in the ready state for one or more operations in at least one secondary cell of the plurality of secondary cells or a second indication of a time duration after which the network entity will be in the ready state for the one or more operations in the at least one secondary cell of the plurality of secondary cells. The first indication includes a set of bits indicating whether the network entity is in the ready state for the one or more operations in one or more secondary cells, including the at least one secondary cell, of the plurality of secondary cells. the time duration is with respect to a timing of the activation information. The processing system is further configured to perform, in accordance with one of the first indication or the second indication, the one or more operations in a first secondary cell of the at least one secondary cell while the network entity is in the ready state.

Another network entity for wireless communication is described. The network entity comprises means for receiving activation information that indicates a plurality of secondary cells. The activation information causes the network entity to transition to a ready state. The network entity further comprises means for transmitting readiness information that includes one of a first indication that the network entity is in the ready state for one or more operations in at least one secondary cell of the plurality of secondary cells or a second indication of a time duration after which the network entity will be in the ready state for the one or more operations in the at least one secondary cell, of the plurality of secondary cells. The first indication includes a set of bits indicating whether the network entity is in the ready state for the one or more operations in one or more secondary cells, including the at least one secondary cell, of the plurality of secondary cells. the time duration is with respect to a timing of the activation information. The network entity further comprises means for performing, in accordance with one of the first indication or the second indication, the one or more operations in a first secondary cell of the at least one secondary cell while the network entity is in the ready state.

A non-transitory computer-readable medium having code for wireless communication stored thereon is described. The code, when executed by a network entity, cause the network entity to receive activation information that indicates a plurality of secondary cells. The activation information causes the network entity to transition to a ready state. The code, when executed by a network entity, further causes the network entity to transmit readiness information that includes one of a first indication that the network entity is in the ready state for one or more operations in at least one secondary cell of the plurality of secondary cells or a second indication of a time duration after which the network entity will be in the ready state for the one or more operations in the at least one secondary cell of the plurality of secondary cells. The first indication includes a set of bits indicating whether the network entity is in the ready state for the one or more operations in one or more secondary cells, including the at least one secondary cell, of the plurality of secondary cells. the time duration is with respect to a timing of the activation information. The code, when executed by a network entity, further causes the network entity to perform, in accordance with one of the first indication or the second indication, the one or more operations in a first secondary cell of the at least one secondary cell while the network entity is in the ready state. A computer program is described comprising the code.

Some examples of the method, network entities, and non-transitory computer-readable medium described herein may further include operations, features, means, or instructions for receiving the activation information for the at least one secondary cell, where the readiness information includes the first indication, and where, transmitting the readiness information including the first indication includes transmitting the readiness information including the first indication in response to receipt of the activation information.

Some examples of the method, network entities, and non-transitory computer-readable medium described herein may further include operations, features, means, or instructions for receiving the activation information that indicates a plurality of secondary cells, where the readiness information includes a set of bits, and where each bit of the set of bits indicates whether the network entity may be in a respective ready state for the one or more operations in each secondary cell of the plurality of secondary cells.

In some examples of the method, network entities, and non-transitory computer-readable medium described herein, the readiness information may be indicative of when the network entity may be in the ready state for each secondary cell of the plurality of secondary cells.

In some examples of the method, network entities, and non-transitory computer-readable medium described herein, a mapping of each secondary cell of the plurality of secondary cells to each bit of the set of bits may be based on respective secondary cell identifiers that correspond to the plurality of secondary cells.

Some examples of the method, network entities, and non-transitory computer-readable medium described herein may further include operations, features, means, or instructions for receiving the activation information that indicates a plurality of secondary cells, and where transmitting the readiness information including the first indication includes transmitting the readiness information including the first indication when the network entity may be in the ready state for the one or more operations in the plurality of secondary cells.

Some examples of the method, network entities, and non-transitory computer-readable medium described herein may further include operations, features, means, or instructions for receiving the activation information that indicates a plurality of secondary cells, and where transmitting the readiness information including the second indication includes transmitting the readiness information including the second indication that indicates a time at which the network entity is to be in the ready state for the one or more operations in the plurality of secondary cells.

Some examples of the method, network entities, and non-transitory computer-readable medium described herein may further include operations, features, means, or instructions for receiving the activation information that indicates a plurality of secondary cells, where transmitting the readiness information including the first indication includes transmitting the readiness information including the first indication each time the network entity may be in a respective ready state for the one or more operations in one or more secondary cells of the plurality of secondary cells.

In some examples of the method, network entities, and non-transitory computer-readable medium described herein, the readiness information indicates the one or more secondary cells of the plurality of secondary cells for which the network entity may be in the respective ready state.

In some examples of the method, network entities, and non-transitory computer-readable medium described herein, the readiness information includes a set of bits, where each bit of the set of bits indicates whether the network entity may be in the respective ready state for the one or more operations in each secondary cell of the plurality of secondary cells, where the method further includes updating the set of bits and retransmitting the readiness information including the updated set of bits when the network entity transitions to the respective ready state for the one or more operations in the one or more secondary cells of the plurality of secondary cells.

In some examples of the method, network entities, and non-transitory computer-readable medium described herein, transmitting the readiness information may include operations, features, means, or instructions for transmitting the readiness information via a first physical uplink control channel resource on a primary cell, via a second physical uplink control channel resource on a cell for which physically uplink control channel resources may be configured or activated, or via a medium access control layer control element message.

In some examples of the method, network entities, and non-transitory computer-readable medium described herein, the cell may be a previously activated secondary cell.

Some examples of the method, network entities, and non-transitory computer-readable medium described herein may further include operations, features, means, or instructions for receiving a resource indication that may be indicative of a resource via which the readiness information is to be transmitted, where transmitting the readiness information includes transmitting the readiness information via the resource.

In some examples of the method, network entities, and non-transitory computer-readable medium described herein, the resource may be a physical uplink shared channel resource triggered by the activation information or a physical uplink control channel resource.

Some examples of the method, network entities, and non-transitory computer-readable medium described herein may further include operations, features, means, or instructions for receiving a signal that activates a physical uplink shared channel resource, where transmitting the readiness information includes transmitting the readiness information via a medium access control layer control element message in the physical uplink shared channel resource.

In some examples of the method, network entities, and non-transitory computer-readable medium described herein, transmitting the readiness information may include operations, features, means, or instructions for transmitting the readiness information in a cell of a secondary cell group including the at least one secondary cell in accordance with a rule that specifies that readiness information for secondary cells is to be transmitted to a cell group including the secondary cells.

In some examples of the method, network entities, and non-transitory computer-readable medium described herein, transmitting the readiness information may include operations, features, means, or instructions for transmitting the readiness information in a primary secondary cell of a secondary cell group including the at least one secondary cell.

In some examples of the method, network entities, and non-transitory computer-readable medium described herein, transmitting the readiness information may include operations, features, means, or instructions for transmitting the readiness information in a previously activated secondary cell of a secondary cell group including the at least one secondary cell.

In some examples of the method, network entities, and non-transitory computer-readable medium described herein, transmitting the readiness information may include operations, features, means, or instructions for transmitting the readiness information in a primary cell in a cell group that includes one or more secondary cells different from the at least one secondary cell.

Some examples of the method, network entities, and non-transitory computer-readable medium described herein may further include operations, features, means, or instructions for receiving a cell indication that may be indicative of a cell in a cell group that includes one or more secondary cells different from the at least one secondary cell, where transmitting the readiness information includes transmitting the readiness information in the cell.

Some examples of the method, network entities, and non-transitory computer-readable medium described herein may further include operations, features, means, or instructions for receiving the activation information for the at least one secondary cell, where the readiness information includes the second indication, and where transmitting the readiness information including the second indication includes transmitting the readiness information including the second indication before receipt of the activation information.

In some examples of the method, network entities, and non-transitory computer-readable medium described herein, transmitting the readiness information may include operations, features, means, or instructions for transmitting a user equipment (UE) capability message including the readiness information.

In some examples of the method, network entities, and non-transitory computer-readable medium described herein, the readiness information includes a respective time duration for each secondary cell of a plurality secondary cells.

In some examples of the method, network entities, and non-transitory computer-readable medium described herein, a first respective time duration for each component carrier of a set of multiple component carriers, or and a second respective time duration for each component carrier group of a set of multiple component carrier groups.

In some examples of the method, network entities, and non-transitory computer-readable medium described herein, the readiness information includes a respective time duration for each feature set per carrier (FSPC), each band, each band combination, each band of a band combination, each downlink feature set, each uplink feature set, each frequency range, each duplexing mode, or a combination thereof.

In some examples of the method, network entities, and non-transitory computer-readable medium described herein, the time duration may be based on whether a secondary cell of the at least one secondary cell may be a known cell or an unknown cell, whether the at least one secondary cell may be in a same timing advance group (TAG) as a previously activated secondary cell, whether the secondary cell may be a primary cell of a secondary physical uplink control channel group, or a combination thereof.

In some examples of the method, network entities, and non-transitory computer-readable medium described herein, the UE capability message indicates a quantity of component carriers to which the second indication may be applicable.

Some examples of the method, network entities, and non-transitory computer-readable medium described herein may further include operations, features, means, or instructions for receiving, prior to receipt of the activation information, information indicative of one or more candidate secondary cell configurations, where the readiness information includes the second indication, and where transmitting the readiness information including the second indication includes transmitting the readiness information including the second indication in response to reception of the information indicative of the one or more candidate secondary cell configurations.

Some examples of the method, network entities, and non-transitory computer-readable medium described herein may further include operations, features, means, or instructions for receiving, prior to receipt of the activation information, configuration information for the at least one secondary cell, where the readiness information includes the second indication, and where transmitting the readiness information including the second indication includes transmitting the readiness information including the second indication in response to receipt of the configuration information.

Some examples of the method, network entities, and non-transitory computer-readable medium described herein may further include operations, features, means, or instructions for receiving, prior to receipt of the activation information and during a radio resource control reconfiguration procedure, configuration information for the at least one secondary cell, where the readiness information including the second indication, and where transmitting the readiness information including the second indication includes transmitting the readiness information including the second indication in response to receipt of the configuration information.

In some examples of the method, network entities, and non-transitory computer-readable medium described herein, receiving the configuration information may include operations, features, means, or instructions for receiving the configuration information in a secondary cell addition message.

In some examples of the method, network entities, and non-transitory computer-readable medium described herein, the configuration information indicates whether a secondary cell of the at least one secondary cell may be a physical uplink control channel secondary cell or a downlink secondary cell.

Some examples of the method, network entities, and non-transitory computer-readable medium described herein may further include operations, features, means, or instructions for performing a multiplexing procedure, where performing the multiplexing procedure includes multiplexing the readiness information with second information of a second transmission that at least partially overlaps with a resource configured for transmission of the readiness information.

In some examples of the method, network entities, and non-transitory computer-readable medium described herein, performing the multiplexing procedure may include operations, features, means, or instructions for multiplexing the readiness information based on a type of the second information of the second transmission, a resource allocation duration of the second transmission, or a combination thereof.

Some examples of the method, network entities, and non-transitory computer-readable medium described herein may further include operations, features, means, or instructions for receiving an instruction to multiplex the readiness information, where performing the multiplexing procedure includes multiplexing the readiness information in accordance with the instruction.

In some examples of the method, network entities, and non-transitory computer-readable medium described herein, a first resource configured for the readiness information at least partially overlaps with a second resource configured for a second transmission, and where transmitting the readiness information includes transmitting the readiness information based on a first priority level associated with the readiness information and a second priority level associated with the second transmission.

In some examples of the method, network entities, and non-transitory computer-readable medium described herein, the first priority level and the second priority level include physical (PHY) layer priority levels.

In some examples of the method, network entities, and non-transitory computer-readable medium described herein, the first priority level may be a higher priority level than the second priority level.

Some examples of the method, network entities, and non-transitory computer-readable medium described herein may further include operations, features, means, or instructions for transmitting a UE capability message that indicates that the network entity supports transmission of the readiness information.

Some examples of the method, network entities, and non-transitory computer-readable medium described herein may further include operations, features, means, or instructions for receiving, in response to the UE capability message, an instruction to transmit the readiness information, where transmitting the readiness information includes transmitting the readiness information in accordance with the instruction.

In some examples of the method, network entities, and non-transitory computer-readable medium described herein, the readiness information indicates that the network entity may be in the ready state for the one or more operations in the at least one secondary cell including one or more first secondary cells configured for uplink communications, one or more second secondary cells configured for downlink communications, or both.

In some examples of the method, network entities, and non-transitory computer-readable medium described herein, the one or more operations include a layer one reference signal received power measurement, a channel state information measurement, receipt of a physical downlink shared channel or a physical downlink control channel, transmission of a random access request, or a combination thereof.

A method of wireless communication performed by a first network entity is described. The method includes transmitting activation information that indicates a plurality of secondary cells. The activation information causes a second network entity to transition to a ready state. The method further includes receiving readiness information that includes one of a first indication that the second network entity is in the ready state for one or more operations in at least one secondary cell of the plurality of secondary cells or a second indication of a time duration after which the second network entity will be in the ready state for the one or more operations in the at least one secondary cell of the plurality of secondary cells. The first indication includes a set of bits indicating whether the network entity is in the ready state for the one or more operations in one or more secondary cells, including at least one secondary cell, of the plurality of secondary cells. the time duration is with respect to a timing of the activation information. The method further includes participating, in accordance with one of the first indication or the second indication, in communication of one or more signals associated with the one or more operations in a first secondary cell of the at least one secondary cell while the second network entity is in the ready state.

A first network entity for wireless communication is described. The first network entity comprises a processing system configured to transmit activation information that indicates a plurality of secondary cells. The activation information causes a second network entity to transition to a ready state. The processing system is further configured to receive readiness information that includes one of a first indication that the second network entity is in the ready state for one or more operations in at least one secondary cell of the plurality of secondary cells or a second indication of a time duration after which the second network entity will be in the ready state for the one or more operations in the at least one secondary cell. The first indication includes a set of bits indicating whether the network entity is in the ready state for the one or more operations in one or more secondary cells, including at least one secondary cell, of the plurality of secondary cells. the time duration is with respect to a timing of the activation information. The processing system is further configured to participate, in accordance with one of the first indication or the second indication, in communication of one or more signals associated with the one or more operations in a first secondary cell of the at least one secondary cell while the second network entity is in the ready state.

Another first network entity for wireless communication is described. The first network entity comprises means for transmitting activation information that indicates a plurality of secondary cells. The activation information causes a second network entity to transition to a ready state. The network entity further comprises means for receiving readiness information that includes one of a first indication that the second network entity is in the ready state for one or more operations in at least one secondary cell of the plurality of secondary cells or a second indication of a time duration after which the second network entity will be in the ready state for the one or more operations in the at least one secondary cell of the plurality of secondary cells. The first indication includes a set of bits indicating whether the network entity is in the ready state for the one or more operations in one or more secondary cells, including at least one secondary cell, of the plurality of secondary cells. the time duration is with respect to a timing of the activation information. The network entity further comprises means for participating, in accordance with one of the first indication or the second indication, in communication of one or more signals associated with the one or more operations in a first secondary cell of the at least one secondary cell while the second network entity is in the ready state.

A non-transitory computer-readable medium having code for wireless communication stored thereon is described. The code, when executed by a first network entity, causes the network entity to transmit activation information that indicates a plurality of secondary cells. The activation information causes a second network entity to transition to a ready state. The code, when executed by a first network entity, further causes the network entity to receive readiness information that includes one of a first indication that the second network entity is in the ready state for one or more operations in at least one secondary cell of the plurality of secondary cells or a second indication of a time duration after which the second network entity will be in the ready state for the one or more operations in the at least one secondary cell of the plurality of secondary cells. The first indication includes a set of bits indicating whether the network entity is in the ready state for the one or more operations in one or more secondary cells, including at least one secondary cell, of the plurality of secondary cells. the time duration is with respect to a timing of the activation information. The code, when executed by a first network entity, further causes the network entity to participate, in accordance with one of the first indication or the second indication, in communication of one or more signals associated with the one or more operations in a first secondary cell of the at least one secondary cell while the second network entity is in the ready state. A computer program is described comprising the code.

Some examples of the method, first network entities, and non-transitory computer-readable medium described herein may further include operations, features, means, or instructions for transmitting the activation information for the at least one secondary cell, where the readiness information includes the first indication, and where receiving the readiness information including the first indication includes receiving the readiness information including the first indication in response to transmission of the activation information.

Some examples of the method, first network entities, and non-transitory computer-readable medium described herein may further include operations, features, means, or instructions for transmitting the activation information that indicates a plurality of secondary cells, where the readiness information includes a set of bits, and where each bit of the set of bits indicates whether the second network entity may be in a respective ready state for the one or more operations in each secondary cell of the plurality of secondary cells.

In some examples of the method, first network entities, and non-transitory computer-readable medium described herein, the readiness information may be indicative of when the second network entity may be in the ready state for each secondary cell of the plurality of secondary cells.

In some examples of the method, first network entities, and non-transitory computer-readable medium described herein, a mapping of each secondary cell of the plurality of secondary cells to each bit of the set of bits may be based on respective secondary cell identifiers that correspond to the plurality of secondary cells.

Some examples of the method, first network entities, and non-transitory computer-readable medium described herein may further include operations, features, means, or instructions for transmitting the activation information that indicates a plurality of secondary cells, and where receiving the readiness information including the first indication includes receiving the readiness information including the first indication when the second network entity may be in the ready state for the one or more operations in the plurality of secondary cells.

Some examples of the method, first network entities, and non-transitory computer-readable medium described herein may further include operations, features, means, or instructions for transmitting the activation information that indicates a plurality of secondary cells, and where receiving the readiness information includes receiving the readiness information including the second indication that indicates a time at which the second network entity is to be in the ready state for the one or more operations in the plurality of secondary cells.

Some examples of the method, first network entities, and non-transitory computer-readable medium described herein may further include operations, features, means, or instructions for transmitting the activation information that indicates a plurality of secondary cells, and where receiving the readiness information including the first indication includes receiving the readiness information including the first indication each time the second network entity may be in a respective ready state for the one or more operations in one or more secondary cells of the plurality of secondary cells.

In some examples of the method, first network entities, and non-transitory computer-readable medium described herein, the readiness information indicates the one or more secondary cells of the plurality of secondary cells for which the second network entity may be in the respective ready state.

In some examples of the method, first network entities, and non-transitory computer-readable medium described herein, the method may include operations, features, means, or instructions for receiving one or more retransmissions of the readiness information that includes the set of bits that may be updated when the second network entity transitions to the respective ready state for the one or more operations in the one or more secondary cells of the plurality of secondary cells.

In some examples of the method, first network entities, and non-transitory computer-readable medium described herein, receiving the readiness information may include operations, features, means, or instructions for receiving the readiness information via a first physical uplink control channel resource on a primary cell, via a second physical uplink control channel resource on a cell for which physically uplink control channel resources may be configured or activated, or via a medium access control layer control element message.

In some examples of the method, first network entities, and non-transitory computer-readable medium described herein, the cell may be a previously activated secondary cell.

Some examples of the method, first network entities, and non-transitory computer-readable medium described herein may further include operations, features, means, or instructions for transmitting a resource indication that may be indicative of a resource via which the readiness information is to be transmitted by the second network entity, where receiving readiness information includes receiving the readiness information via the resource.

In some examples of the method, first network entities, and non-transitory computer-readable medium described herein, the resource may be a physical uplink shared channel resource triggered by the activation information or a physical uplink control channel resource.

Some examples of the method, first network entities, and non-transitory computer-readable medium described herein may further include operations, features, means, or instructions for transmitting a signal that activates a physical uplink shared channel resource, where receiving the readiness information includes receiving the readiness information via a medium access control layer control element message in the physical uplink shared channel resource.

In some examples of the method, first network entities, and non-transitory computer-readable medium described herein, receiving the readiness information may include operations, features, means, or instructions for receiving the readiness information in a primary secondary cell of a secondary cell group including the at least one secondary cell.

In some examples of the method, first network entities, and non-transitory computer-readable medium described herein, receiving the readiness information may include operations, features, means, or instructions for receiving the readiness information in a primary secondary cell of a secondary cell group including the at least one secondary cell.

In some examples of the method, first network entities, and non-transitory computer-readable medium described herein, receiving the readiness information may include operations, features, means, or instructions for receiving the readiness information in a previously activated secondary cell of a secondary cell group including the at least one secondary cell.

In some examples of the method, first network entities, and non-transitory computer-readable medium described herein, receiving the readiness information may include operations, features, means, or instructions for receiving the readiness information in a primary cell in a cell group that includes one or more secondary cells different from the at least one secondary cell.

Some examples of the method, first network entities, and non-transitory computer-readable medium described herein may further include operations, features, means, or instructions for transmitting a cell indication that may be indicative of a cell in a cell group that includes one or more secondary cells different from the at least one secondary cell, where receiving the readiness information includes receiving the readiness information in the cell.

Some examples of the method, first network entities, and non-transitory computer-readable medium described herein may further include operations, features, means, or instructions for transmitting the activation information for the at least one secondary cell, where the readiness information includes the second indication, and where receiving the readiness information including the second indication includes receiving the readiness information including the second indication when the readiness information may be received before transmission of the activation information.

In some examples of the method, first network entities, and non-transitory computer-readable medium described herein, receiving the readiness information may include operations, features, means, or instructions for receiving a UE capability message including the readiness information.

In some examples of the method, first network entities, and non-transitory computer-readable medium described herein, the readiness information includes a respective time duration for each secondary cell of a plurality secondary cells.

In some examples of the method, first network entities, and non-transitory computer-readable medium described herein, a respective first time duration for each component carrier of a set of multiple component carriers, or and a respective second time duration for each component carrier group of a set of multiple component carrier groups.

In some examples of the method, first network entities, and non-transitory computer-readable medium described herein, the readiness information includes a respective time duration for each feature set per carrier (FSPC), each band, each band combination, each band of a band combination, each downlink feature set, each uplink feature set, each frequency range, each duplexing mode, or a combination thereof.

In some examples of the method, first network entities, and non-transitory computer-readable medium described herein, the time duration may be based on whether a secondary cell of the at least one secondary cell may be a known cell or an unknown cell, whether the at least one secondary cell may be in a same timing advance group (TAG) as a previously activated secondary cell, whether the secondary cell may be a primary cell of a secondary physical uplink control channel group, or a combination thereof.

In some examples of the method, first network entities, and non-transitory computer-readable medium described herein, the UE capability message indicates a quantity of component carriers to which the second indication may be applicable.

Some examples of the method, first network entities, and non-transitory computer-readable medium described herein may further include operations, features, means, or instructions for transmitting, prior to transmission of the activation information, information indicative of one or more candidate secondary cell configurations, where the readiness information includes the second indication, and where receiving the readiness information including the second indication includes receiving the readiness information that includes the second indication in response to transmission of the information indicative of the one or more candidate secondary cell configurations.

Some examples of the method, first network entities, and non-transitory computer-readable medium described herein may further include operations, features, means, or instructions for transmitting, prior to transmission of the activation information and during a radio resource control reconfiguration procedure, configuration information for the at least one secondary cell, where the readiness information includes the second indication, and where receiving the readiness information including the second indication includes receiving the readiness information including the second indication in response to transmission of the configuration information.

In some examples of the method, first network entities, and non-transitory computer-readable medium described herein, transmitting the configuration information may include operations, features, means, or instructions for transmitting the configuration information in a secondary cell addition message.

In some examples of the method, first network entities, and non-transitory computer-readable medium described herein, the configuration information indicates whether a secondary cell of the at least one secondary cell may be a physical uplink control channel secondary cell or a downlink secondary cell.

In some examples of the method, first network entities, and non-transitory computer-readable medium described herein, receiving the readiness information may include operations, features, means, or instructions for receiving the readiness information that may be multiplexed with second information of a second transmission that at least partially overlaps with a resource configured for transmission of the readiness information.

In some examples of the method, first network entities, and non-transitory computer-readable medium described herein, receiving the readiness information that may be multiplexed with the second information may include operations, features, means, or instructions for receiving the readiness information that may be multiplexed based on a type of the second information of the second transmission, a resource allocation duration of the second transmission, or a combination thereof.

Some examples of the method, first network entities, and non-transitory computer-readable medium described herein may further include operations, features, means, or instructions for transmitting an instruction to multiplex the readiness information, where receiving the readiness information that may be multiplexed with the second information includes receiving the readiness information that may be multiplexed in accordance with the instruction.

In some examples of the method, first network entities, and non-transitory computer-readable medium described herein, a first resource configured for the readiness information at least partially overlaps with a second resource configured for a second transmission, and where receiving the readiness information includes receiving the readiness information based on a first priority level associated with the readiness information and a second priority level associated with the second transmission.

In some examples of the method, first network entities, and non-transitory computer-readable medium described herein, the first priority level and the second priority level include physical (PHY) layer priority levels.

In some examples of the method, first network entities, and non-transitory computer-readable medium described herein, the first priority level may be a higher priority level than the second priority level.

Some examples of the method, first network entities, and non-transitory computer-readable medium described herein may further include operations, features, means, or instructions for receiving a UE capability message that indicates that the second network entity supports transmission of the readiness information.

Some examples of the method, first network entities, and non-transitory computer-readable medium described herein may further include operations, features, means, or instructions for transmitting, in response to the UE capability message, an instruction to transmit the readiness information, where receiving the readiness information includes receiving the readiness information in accordance with the instruction.

In some examples of the method, first network entities, and non-transitory computer-readable medium described herein, the readiness information indicates that the second network entity may be in the ready state for the one or more operations in the at least one secondary cell including one or more first secondary cells configured for uplink communications, one or more second secondary cells configured for downlink communications, or both.

In some examples of the method, first network entities, and non-transitory computer-readable medium described herein, the one or more operations include a layer one reference signal received power measurement, a channel state information measurement, receipt of a physical downlink shared channel or a physical downlink control channel, transmission of a random access request, or a combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communication system that supports fast secondary cell (SCell) activation in accordance with one or more aspects of the present disclosure.

FIG. 2 shows an example of a wireless communication system that supports fast SCell activation in accordance with one or more aspects of the present disclosure.

FIG. 3 shows an example of a process flow that supports fast SCell activation in accordance with one or more aspects of the present disclosure.

FIGS. 4 and 5 show block diagrams of devices that support fast SCell activation in accordance with one or more aspects of the present disclosure.

FIG. 6 shows a block diagram of a communications manager that supports fast SCell activation in accordance with one or more aspects of the present disclosure.

FIG. 7 shows a diagram of a system including a device that supports fast SCell activation in accordance with one or more aspects of the present disclosure.

FIGS. 8 and 9 show block diagrams of devices that support fast SCell activation in accordance with one or more aspects of the present disclosure.

FIG. 10 shows a block diagram of a communications manager that supports fast SCell activation in accordance with one or more aspects of the present disclosure.

FIG. 11 shows a diagram of a system including a device that supports fast SCell activation in accordance with one or more aspects of the present disclosure.

FIGS. 12 and 13 show flowcharts illustrating methods that support fast SCell activation in accordance with one or more aspects of the present disclosure.

### DETAILED DESCRIPTION

To support improved throughput, a user equipment (UE) may be configured with multiple cells for communications. For example, the UE may be configured with a primary cell (PCell) and multiple secondary cells (SCells). SCells may be deactivated to support UE power savings and activated to support UE improved throughput. When the UE receives an activation command to activate an SCell, the UE may perform various operations to start operations in the activated SCell. Such operations may include processing of the activation command, radio-frequency (RF) tuning, measurements, and measurement reporting. The UE may send a channel state information (CSI) report at or before a specified time duration after receiving the activation command. However, a large activation latency may result in an application layer of the UE reducing a data rate even though the application layer could use the increased data rate resulting from activation of the SCell. For example, due to a large activation latency, the application layer reduces the data rate before the SCell is activated, which may defeat or limit the enhancement of using SCells.

UEs may be able to activate and start communicating in an activated SCell prior to specified timelines. Techniques described herein support transmission of one or more indications of a ready state associated with to-be-activated SCell. For example, the UE may report an advanced timeline for one or more SCells that may be activated based on an activation command (e.g., a duration is transmitted prior to receiving the command). In other cases, the UE reports the ready state after receiving the activation command. For example, after the network transmits signaling to activate a SCell, when the UE is ready for communications in the SCell, the UE transmits an indication of readiness. Thus, the network and the UE may initiate communications at a faster timeline, which may result in improved communication efficiency and throughput. These and other techniques are described in further detail with respect to the figures.

Aspects of the disclosure are initially described in the context of wireless communication systems. Aspects of the disclosure are further described with respect to a wireless communication system illustrating an SCell activation timeline and a process flow illustrating signaling supporting SCell activation. Aspects of the disclosure are further illustrated by and described with reference to apparatus diagrams, system diagrams, and flowcharts that relate to fast SCell activation.

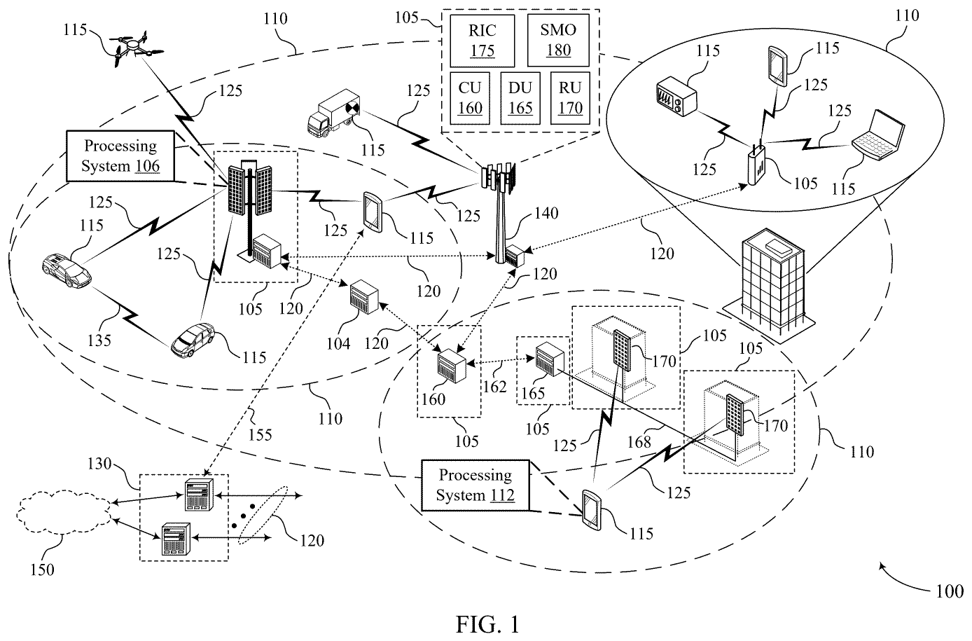

FIG. 1 shows an example of a wireless communication system 100 that supports fast SCell activation in accordance with one or more aspects of the present disclosure. The wireless communication system 100 may include one or more devices, such as one or more network devices (e.g., network entities 105), one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communication system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communication systems (e.g., the wireless communication system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support fast SCell activation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communication system 100 may support communication with a UE 115 using carrier aggregation or multicarrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communication system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communication system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communication system 100 (e.g., the network entities 105, the UEs 115, or both) may have hardware configurations that support communications using a particular carrier bandwidth or may be configurable to support communications using one of a set of carrier bandwidths. In some examples, the wireless communication system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multicarrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems, such as the wireless communication system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communication system 100 may include, for example, a heterogeneous network in which different types of the network entities 105 support communications for coverage areas 110 (e.g., different coverage areas) using the same or different RATs.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples. a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communication system 100 may support multicarrier aggregation whereby the UEs 115 may be configured with multiple cells for communications with one or more network entities 105. For example, the UE 115 may be configured with a PCell and multiple SCells. The SCells may be deactivated for power savings at the UE 115 and activated when improved throughput is used for communications. The network entities 105 may support various signaling techniques to activate SCells at the UEs 115, and the UEs 115 may perform various operations in accordance with various activation timelines to activate SCell safter receiving activation signaling (also referred to as, e.g., activation information or command). However, the UEs 115 may perform various operations to support communications in the activated SCell, and these operations may introduce activation latency. As such, the network entities 105 may start communications in the SCell after an activation timeline, which in some cases, is based on a worst case scenario. Such activation latency may cause premature reduction in data rates at the application layer of the UEs 115, which may defeat the purpose of multicarrier aggregation.

Techniques described herein support the UEs 115 transmitting indications of readiness information associated with SCells that may be or are to be activated. For example, prior to receiving activation information (i.e., activation signaling) from a network entity 105, the UE 115 may transmit UE capability information that indicates that the UE 115 may activate SCells at a faster rate than the specified timelines. Additionally, or alternatively, after receiving the activation information indicating one or more SCells, the UE may transmit readiness information that indicates that the UE 115 is in a ready state for one or more operations in the one or more SCells. As such, activation latency may be reduced, which may support improved communication efficiency.

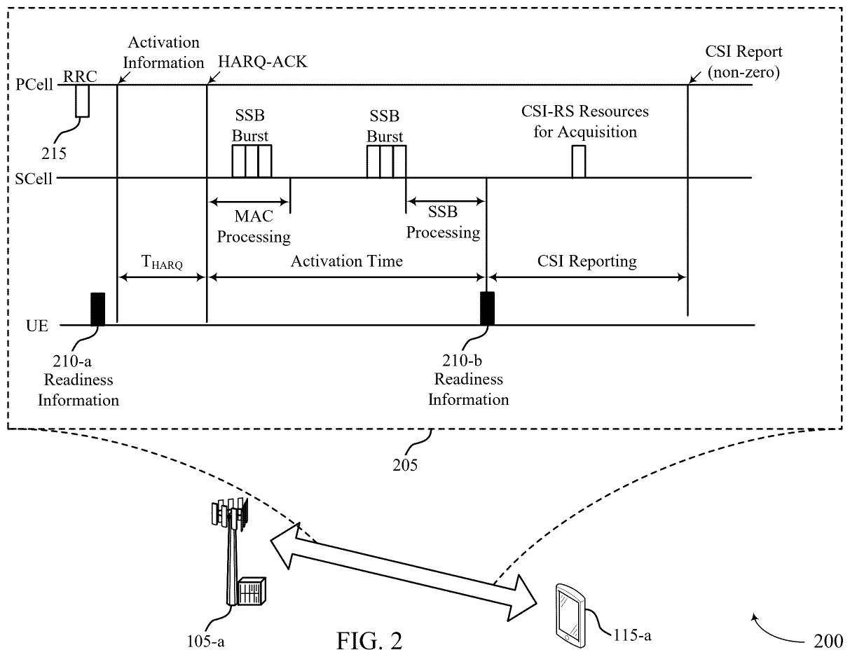

FIG. 2 shows an example of a wireless communication system 200 that supports fast SCell activation in accordance with one or more aspects of the present disclosure. The wireless communication system 200 includes a network entity 105-a and a UE 115-a, which may be examples of the network entities 105 and the UEs 115 as described with respect to FIG. 1.

The network entity 105-a and the UE 115-a may support multicarrier operations as described herein. In such cases, the UE 115-a may be configured with (e.g., by the network entity 105-a) with one or more primary cells (PCell) and one or more SCells. In some cases, an SCell may be configured but inactive, and the UE 115-a may not perform various operations, or may perform limited operations, in an inactive SCell. A SCell may be activated by the network and the UE 115-a may perform various operations in the activated SCell.

An SCell may be activated using various signaling techniques. In some examples, one or more SCells may be directly activated after RRC configuration of the SCells. For example, after configuration of an SCell, the SCell may be deactivated as a default, unless a parameter (e.g., sCellState) is set to activated for the SCell by upper layers. SCells may be activated or deactivated using MAC-CE signaling. Additionally, enhanced SCell activation/deactivation may be supported using MAC-CE with temporary tracking reference signals (TRS). In such cases, since the activation time may depend on SSB measurements (and SSB may be sparse), some wireless communication systems may support aperiodic TRS (A-TRS) for automatic gain control (AGC) and tracking, which may be triggered by SCell activation MAC-CE. With the A-TRS, the UE 115-a may not wait for the SSBs and activation time can be reduced.

Additionally, SCells may be activated based on bandwidth part (BWP) switching, which may be part of BWP dormancy procedures. For example, the UE 115-a may be configured with one or more downlink BWPs per SCell, and one of the BWPs may have a dormant state. When the UE is instructed to switch to the dormant BWP in the SCell, the UE will switch to a state where a subset of operations is performed. When the UE is instructed to switch to a BWP that is non-dormant in the SCell, the SCell is switched to an active state.

When an SCell is activated, the UE 115-a may perform various operations, and when an SCell is deactivated, the UE 115-a may suspend at least some of these various operations. For example, in an active SCell, the UE 115-a may perform sounding reference signal (SRS) transmissions on the SCell, CSI reporting for the SCell, physical downlink control channel (PDCCH) monitoring on and for the SCell, physical uplink control channel (PUCCH) transmissions on the SCells (if configured). If an SCell is deactivated, the UE 115-a may not transmit SRS on the SCell, may not report SCI for the SCell, may not transmit on uplink shared channels on the SCell, may not transmit on a random access channel (RACH) of the SCell, may not monitor the PDCCH on or for the SCell, and/or may not transmit PUCCH on the SCell. Additionally, the UE 115-a may be expected to suspend or abort various operations on an SCell with an active BWP that is switched to a dormant BWP. For example, if the active BWP is a dormant BWP, the UE 115-a may be expected to stop an active BWP timer for the cell (if running), not monitor the PDCCH on or for the BWP, not receive downlink shared channel transmission on the BWP, not report CSI on the BWP (the UE 115-a may report CSI except aperiodic CSI for the BWP), not transmit the SRS on the BWP, not transmit uplink shared channel transmissions on the BWP, not transmit on the RACH on the BWP, not transmit PUCCH on the BWP, among other operations. These are example downlink and uplink operations that a UE suspends or aborts on a SCell whose DL BWP is switched to such a dormant BWP. In some cases, there is no separate uplink and downlink dormancy, and as such, when a downlink BWP is switched to a dormant state, the UL activities may be suspended or aborted as described herein. In some examples, the UE 115-a may measure periodic CSI reference signals, perform AGC, and perform beam management (if configured), while the BWP is in a dormant state. Such operations (e.g., CSI-RS measurements, AGC, and beam management) may allow the UE to activate the SCell, when instructed via PDCCH and/or DCI to switch the active BWP to a non-dormant BWP.

When MAC-CE is used to activate an SCell, the UE may receive a PDCCH that schedules a physical downlink shared channel (PDSCH) that carries the MAC-CE. After receiving the MAC-CE, various operations may be performed by the UE 115-a before the SCell is fully active at the UE 115-a. For example, the UE 115-a may perform MAC-CE processing, HARQ-ACK signaling, radio-frequency (RF) retuning and warm up procedures, building RF scripts/software, AGC setting, master information block (MIB) reading (if the SCell is unknown), and time/frequency synchronization. When the UE 115-a has performed such operations, the UE 115-a may perform valid channel quality indicator (CQI) reporting. Use of the dormant bandwidth part activation procedure may reduce the time for SCell activation for valid CQI reporting.

It is desirable, to improve throughput, for SCells to be accessible with low latency while also reducing power consumption at the UE. For example, low latency (e.g., 0 ms) may be achieved by keeping SCells in an activated state, but keeping SCells active may drain UE power. Power savings may be achieved by keeping SCells in the deactivated state, but a long activation latency may defeat the purpose of multicarrier aggregation. For example, an application layer on the UE is demanding improved throughput via multicarrier aggregation, the activation latency may result in the application reducing the data rate before the SCells are fully activated, which results in a smaller data pipe and reduced throughput. SCell activation latency may depend on multiple factors including the frequency range of the SCell (e.g., FR1 or FR2), whether the SCell is known or unknown (defined in further detail herein), a reporting period and measurement cycle, the activation mechanism, whether the activated SCell is in the PCell of a secondary PUCCH group, whether the SCell is in a different tracking area group (TAG), and scheduling inefficiencies (e.g., waiting for multiple rounds of CSI reporting before scheduling, type of CSI-RS and report).

Various timelines for SCell activation may be defined, and the timelines may be dependent on various conditions or scenarios. Although the timeline for activation may change based on the scenario, the UE 115-a may report a non-zero CQI (e.g., a valid CQI) for the SCell when the SCell is activated.

An example timeline 205 is shown for SCell activation. As shown in the timeline, when the activation information (e.g., an SCell activation MAC-CE) is received and applied at the UE 115-a, the UE 115-a is to start reporting CSI. A latest timeline for sending a non-zero CQI may be specified, but if the UE 115-a is not ready before that, the UE 115-a may transmit a report with a CQI index of 0. Thus, the CSI reporting timeline may be based on the uncertainty in acquiring the first available CSI-RS +the UE processing time for CSI reporting+the uncertainty in acquiring the first available CSI reporting resource.

For SCell activation, CSI-RS and CSI reporting may be periodic or aperiodic. To reduce the SCell activation latency, aperiodic CSI-RS triggering and aperiodic CSI reporting may be preferred as aperiodic CSI-RS may reduce the wait time to reach the next configured occasion of CSI-RS resources and reporting resources.

Considering the aperiodic CSI-RS triggering and reporting, given that the network does not know whether the UE 115-a is in a ready state before the specified timelines or not (e.g., loops, such as time/frequency synchronization and AGC, have converged, and steady CSI can be reported), the network usually follows the specified timeline (the worst-cases), and triggers the CSI-RS and report the specified timelines (e.g., after the SSB processing timeline shown in timeline 205). Some network implementations may be more aggressive and trigger the aperiodic measurement and report even before the end of the specified timelines, but if the UE 115-a is not ready, the UE 115-a may either skip the report or transmit inaccurate report.

With periodic CSI-RS and reporting, although SCell activation is expected to be longer, the network may interpret a non-zero CSI report as an indication of early readiness of the UE 115-a on the target SCell. In the case of periodic reporting, the UE 115-a cannot skip the report and the UE 115-a may transmit a report. However, the reported CSI may not be accurate derived after all the loops have converged (e.g., the UE is in the ready state).

Thus, techniques described herein support signaling that the UE 115-a uses to report to the network that the UE 115-a is ready or can be ready before the worst-case timelines. For example, the specified timeline for a specific scenario may be based on observing x SSB samples to acquire coarse/fine AGC or coarse/fine time/frequency synchronization, while the UE 115-a may perform time/frequency synchronization and AGC setting with less than x SSB samples. Using the techniques described herein, with aperiodic CSI-RS triggering and aperiodic CSI-RS reporting, the network may not wait based on the worst-case timelines. Even for more aggressive network implementations, with additional signaling, uplink and/or downlink resources may not be wasted. With periodic CSI and reporting and using readiness information reporting, the network may be able to determine whether the received CSI report is accurate or not.

The UE 115-a may be in the “ready state” for SCell activation based on one or more various operations. For example, the UE 115-a may be in the ready state when the UE 115-a is ready to measure the L1-RSRP (reference signal received power) based on non-periodic reference signals. For example, for unknown SCell activation, L1-RSRP measurement and reporting may be performed after loop convergence, and the measurement may be based on aperiodic triggering or semi-periodic CSI-RS for which the network may use to determine when to start transmitting the reference signals. The UE 115-a may additionally, or alternatively, be in the ready state when the UE 115-a is ready to perform CSI measurements based on the aperiodic or semi-periodic CSI-RS. The UE 115-a may additionally, or alternatively, be in the ready state when the UE 115-a is ready to receive a PDCCH and/or PDSCH. The UE 115-a may additionally, or alternatively, be in the ready state when the UE 115-a is ready to transmit a random access request (random access preamble) in PRACH resources (if the SCell belongs to a different TAG than the primary TAG (PTAG) and requires an uplink synchronization procedure).

Various signaling options for indicating the ready state (e.g., readiness information) are described herein. In accordance with one or more first options, readiness information may be reported prior to receiving activation information, such as an activation command. For example, the UE 115-a may report the readiness information via UE capability signaling (e.g., a readiness information 210-a), and the readiness information may indicate a time duration, after receiving the activation command, after which the UE 115-a can be in the ready state. The time duration may be upper bounded by the worst-case values defined in the specification (e.g., the UE 115-a may not be permitted to report a timeline longer than the worst case scenario).

Thus, when the UE 115-a reports supported carrier aggregation and/or dual connectivity band combinations, the UE 115-a additionally signals whether the UE 115-a can be ready on an SCell faster. Additionally, or alternatively, the UE may report such readiness timelines per group of component carriers (CCs), for all CCs, or per CC, a value that reflects the faster timeline. Additionally, or alternatively, the UE may report the value(s) for the faster timeline per feature set per carrier (FSPC), per band, per band combination, per downlink/uplink feature set, per band of band combination, and the value may be differentiated across different frequency ranges or duplexing modes (e.g., frequency division duplex bands, time division duplex bands, sub-band full duplex bands). Additionally, or alternatively, the shorted timelines may be reported independently and separately based on other factors such as whether the SCell is known or unknown, whether the SCell is in the same TAG as other already activated component carriers or not, whether the SCell is a PCell for the secondary PUCCH group or not, etc.

In some examples, the capability signaling may also include an indication of the quantity of component carriers for which the UE 115-a is able to expedite SCell activation. The quantity of component carries may reflect the quantity of component carries which can be simultaneously activated with the faster timeline, or the quantity of component carries may refer to the quantity of component carriers on which the enhanced timeline is supported.

The capability signaling including the readiness information (e.g., readiness information 210-a) may be based on an expected configuration (e.g., a pre-configuration). For example, the reporting of the readiness information may be based on a network inquiry. In such cases, before configuring SCells (e.g., via RRC signaling), the network may indicate potential or candidate configurations of multicarrier operation to the UE 115-a. The potential or candidate configurations may be indicative of bands, band combinations, a quantity of component carriers, a bandwidth class, etc. In response to the inquiry, the UE 115-a may transmit a UE capability report including the readiness information as described herein.

In accordance with another option, the capability signaling including the readiness information (e.g., the readiness information 210-a) may be transmitted by the UE 115-a to the network after the SCells are configured (e.g., via RRC signaling) but before the SCells are activated via activation information (e.g., an activation command). For example, the PCell transmits RRC signaling 215, and the UE 115-a transmits the readiness information 210-a in response to the RRC signaling 215. This technique may be used for different activation mechanisms except for direct SCell activation via RRC, since, according to this technique, configuration and activation occur via the same signaling. Signaling readiness information after SCell configuration (e.g., jointly or separately) may allow the network to trigger the readiness information report and schedule resources for the UE, such as via RRC, MAC-CE, or layer 1 signaling (e.g., via PDCCH). If the activation information (e.g., the activation command) is received before the UE 115-a is able to report the shorter timelines, the UE 115-a and the network may fall back to following the specified timelines.

The pre-configuration and post-configuration UE capability report that indicates the readiness information may be considered as part of a dynamic capability update. For example, the UE capability may be communicated to the network via the RRC reconfiguration procedure, such as during SCell addition. This technique may allow the UE 115-a to better reflect the capability based on the given configurations, such as the SSB measurement timing configuration (SMTC) of the to-be-added SCell, measurement occasions (MO) of the SCell, SSB periodicity of the SCell, and the relationship of the SCell with other serving cells. Additionally, this approach enables the UE 115-a to optimize the capability, considering the dynamic nature of the SCell activation timeline (the timeline heavily depends on multiple factors at the moment of SCell activation command reception). Otherwise, the UE 115-a may report the capability more conservatively. Note that this type of UE capability signaling scheme can be considered as “inquiry-based UE capability,” as the inquiry from the network to the UE 115-a and the corresponding report from the UE to the network may occur even before the SCell is added as an SCell at the UE. For example, after receiving a measurement report from the UE 115-a, the network may query whether the SCell may be added and/or activated faster than reference timelines. This query by the network may include specific information to provide the UE 115-a with more context, such as whether the target cell is a candidate PUCCH SCell or a downlink-only SCell. This detailed context helps the UE 115-a to better understand the requirements and determine the capabilities accordingly.

In accordance with another option for transmitting readiness information for SCells, the UE 115-a may not report a shorter timeline. Rather, after receiving the activation information (e.g., activation command), the UE 115-a may indicate, to the network, when the UE 115-a is ready on the target SCell (e.g., readiness information 210-b). This option may give the UE 115-a the flexibility to decide how fast the UE 115-a is to become ready on the SCell. For example, the UE 115-a may implement a slower ready state timeline for power saving purposes or the inability of the UE 115 to be ready faster due to operations in already activated SCells.

The ready state indication included in the readiness information 210-b may include a single-bit indication or a multi-bit indication with a bit for each to-be-activated SCell. In the case of the single-bit indication, the single-bit may indicate when each of the to-be-activated SCells are activated. Thus, if the activation information indicates three SCells, the single-bit may indicate when the UE 115-a is in the ready state for the three SCells. The ready or not ready state indication may be carried via single bit (e.g., “1” for ready and “0 ” for not ready) or one state (e.g., ready) may be indicated via a fixed sequence when the UE 115-a transitions to the ready state. With the multi-bit indication, additional information such as an indication of when the UE 115-a is to be ready (e.g., a time duration) may be indicated. As such, this indication may be an indication of a future time, such as an absolute time, based on a quantity of slots (e.g., with the sub-carrier spacing of the same cell or another reference cell). If there are multiple SCells for the readiness report, the order of the bits or bit sequences may follow the serving cell identifier among the indicated to-be-activated SCells. That is, the mapping of the SCells to a bit position may be based on a sequential ordering of the SCell identifiers.

In cases when multiple SCells are to be activated at the same time (e.g., multiple SCells indicated in the activation information), various signaling options may be used to signal ready states. For example, the UE 115-a may send an indication when or after the UE 115-a is ready in all of the indicated to-be-activated SCells, or the UE 115-a may indicate a time in the future when the UE 115-a will be ready in all of the SCells. Additionally, or alternatively, the UE 115-a may send one indication per to-be-activated SCell separately. In such cases, the indications may be sent multiple times, such that an indication is sent each time one or more SCells of the group is ready. In such cases, the index of the SCells for which the UE 115-a is ready is included in the readiness information report. Alternatively, the indication may be sent once or multiple times for all to-be-activated SCells. In each message, the UE 115-a indicates, per SCell, whether the UE 115-a is ready (‘1’) or not yet ready (‘0’) or provide timeline on when the UE 115-a will be ready. In such cases, for the SCell-readiness information previously sent to the network as ready (e.g., “1”), subsequent messages should not change the corresponding ready state to not ready (e.g., readiness should remain consistent in the subsequent messages). In other words, the readiness state change is allowed from “0” to “1” for the same SCell but not allowed from “1” to “0” for the same SCell.

The readiness information 210-b may be transmitted via layer 1 (L1) and/or layer 2 (L2) signaling. For example, the indication can be transmitted on a PUCCH resource on a PCell, a PUCCH resource on a PUCCH cell (e.g., a cell configured for PUCCH transmission), or via MAC-CE signaling. For example, specific PUCCH resources are configured for the UE 115-a. Starting from the reception of an SCell activation command, these resources are used for the transmission of ready state indication (e.g., the readiness information 210-b). Once the indication is sent, the use of these resources may be stopped. The same design can be adopted for the transmission of the ready indication over a MAC-CE. The activation information may trigger semi-persistent physical uplink shared channel (PUSCH) (SP-PUSCH) resources to be used or may activate a configured grant PUSCH (CG-PUSCH) configuration for the UE. These resources may be limited to a PUCCH cell or could be on any already activated SCell. Alternatively, the MAC-CE carrying the readiness information may be transmitted via PUSCH, which is dynamically granted on any active CC.

In cases when the UE 115-a is configured with dual PUCCH groups or configured with dual-connectivity, the following cases for the transmission of the ready state indication related to the CCs in the second PUCCH group or SCG can be considered. In a first option, the ready state indication for the cells in each cell/PUCCH group are limited to transmission on the cells in the same group. In such cases, the readiness information 210-b is transmitted on the primary SCell (PSCellof the cell group. In cases when the transmission of the readiness information is limited to the PSCell, the ready state indication for the SCells in the second group/CG is transmitted on the PSCell of the second group/CG. Otherwise, the indication can be sent on any other indicated, already active, SCell in the same group. However, if the PSCell of the second group/CG is not activated, then no other CC in the same group is activated. The PSCell is among the first group of CCs to be activated. Thus, in accordance with the rule that limits transmission of the readiness information on the cells in the same group, the ready state indication may not be applicable and the UE 115-a and the network entity 105-a may follow the specified timelines.

In accordance with another option when the UE 115-a is configured with dual PUCCH groups or configured with dual-connectivity, the readiness state indication for the SCells in each cell/PUCCH group may be permitted to be sent on the cells of other groups. In cases when the PSCell of the second group/CG (e.g., the group separate from the group including the to-be-activated SCells) is already activated, the transmission of the readiness information may be limited to the PSCell of the second group or the first group or choice of group may be configured or indicated to the UE 115-a (e.g., via a field in the SCell activation command). In cases when the PSCell of the second group/CC is not activated, then the readiness information may be permitted only in a cell of the group including the to-be-activated SCells. Alternatively, the readiness information is transmitted on any PUCCH cell of the first cell group (including the to-be-activated SCells), or another active SCell in the first group. In some examples, the choices between these various options may be configured at or signaled to the UE 115-a.

In some cases, the channel that is to convey the readiness information 210 may overlap in time and/or frequency domain with other uplink transmissions. In such cases, if the overlapping channels cannot be simultaneously transmitted, then the UE 115-a may multiplex the data of each channel. Additionally, or alternatively, the overlapping channels cannot be simultaneously transmitted, then one channel may be prioritized over the other. In cases where multiplexing is allowed, the ready state information may be multiplexed with other transmissions, or whether to multiplex or not may be dependent on the content of the other channels (e.g., the readiness information 210 is multiplexed with HARQ-ACK information bits but not CSI). Additionally, whether to multiplex or not may be dependent on attributes of the other channel such as the channel type (e.g., PUSCH or PUCCH), the length of allocation in the time domain of the other channel, and/or the PHY-layer priority.

In cases when the overlapping channels are not simultaneously transmitted and one channel is prioritized over the other, the ready state information may be given a priority that is higher than the other channel. This rational may be based on the notion that adding more bandwidth via SCell activation is more valuable than serving traffic on the limited bandwidth of the already activated cells. In some cases, the priority may be dependent on the type of the other channels, the content of the other channels, or attributes as described above. In some cases, the prioritization of the readiness information 210, whether the readiness information 210 is to be multiplexed, or both, may be configured by the network entity 105-a and/or dynamically indicated to the UE 115-a. Additionally, or alternatively, the prioritization of the readiness information 210 may be based on the quantity of already activated SCells and/or the quantity of to-be-activated SCells. For example, if the quantity of already activated SCells is greater than a threshold, then the priority of the readiness information 210 is set to a lower priority. Alternatively, if the quantity of already activated SCells is less than the threshold, then the priority of the readiness information 210 is set to a higher priority such as to support quicker activation of the SCell. Additionally, if the quantity of to-be-activated SCells (e.g., based on the quantity of SCells indicated in the activation information) is greater than a threshold, then the readiness information may be given a higher priority than if the quantity of to-be-activated SCells is less than the threshold. Additionally, or alternatively, the bandwidth of SCells that are to be activated may be considered in assigning a priority to the readiness information 210.

In some cases, whether the UE 115-a transmits the readiness information may be based on the capability of the UE 115-a. For example, the UE transmits a UE capability report that indicates that the UE 115-a supports transmission of the readiness information 210. The capability may be signaled based on different granularities such as per UE, per band, or per downlink or uplink frequency spectrum. In some cases, the configured SCells may be activated in downlink, uplink, or both directions separately. In such cases, the capability of transmitting readiness information 210 may be dependent on whether the SCell is activated in downlink, uplink, or both directions, and the capability may be separately indicated. UEs that do not support transmission of readiness information may use the specified timelines and behaviors. For UEs that do support transmission of readiness information, the applicability and use may be based on the network configuration. For example, after receiving the capability report, the network entity 105-a may signal activation/configuration of transmission of the readiness information 210. In cases where DL and UL SCell activation is decoupled, the techniques described herein may be separately or jointly considered for downlink SCell activation and uplink SCell activation. For example, when the readiness information 210-b is transmitted in response to an SCell activation command, the readiness information 210-b may be separately sent for downlink SCell activation and uplink SCell activation.

Various techniques and procedures described herein may be dependent on whether the to-be-activated SCell is known or unknown. For example, whether the UE is able to activate an SCell in an expedited timeline may be dependent on whether the SCell is known or unknown. In a first frequency range (FR1), a known SCell may satisfy the following conditions (otherwise the SCell is unknown): During a period equal to max max(5*measCycleSCell, 5*DRX cycles) for FR1 before the reception of the SCell activation command, the UE 115-a has sent a valid measurement report for the SCell being activated, and the SSB measured remains detectable according to the cell identification conditions specified in other clauses. The SCell is considered known if the SSB measured during the period equal to max(5*measCycleSCell, 5*DRX cycles) also remains detectable during the SCell activation latency according to the cell identification conditions specified in other clauses. In a second frequency range (FR2), a known SCell may satisfy the following conditions (otherwise the SCell is unknown): During the period equal to 4 s for UEs supporting power class1 and 3 s for UEs supporting power class 2/3/4 before the UE receives the last activation command for PDCCH TCI, PDSCH TCI (when applicable) and semi-persistent CSI-RS for CQI reporting (when applicable), the UE has sent a valid L3-RSRP measurement report with SSB index, the SCell activation command is received after L3-RSRP reporting and no later than the time when UE receives MAC-CE command for TCI activation. An SCell is considered known if, during the period from L3-RSRP reporting to the valid CQI reporting, the reported SSBs with indexes remain detectable according to the cell identification conditions specified in other clauses, and the TCI state is selected based on one of the latest reported SSB indexes.

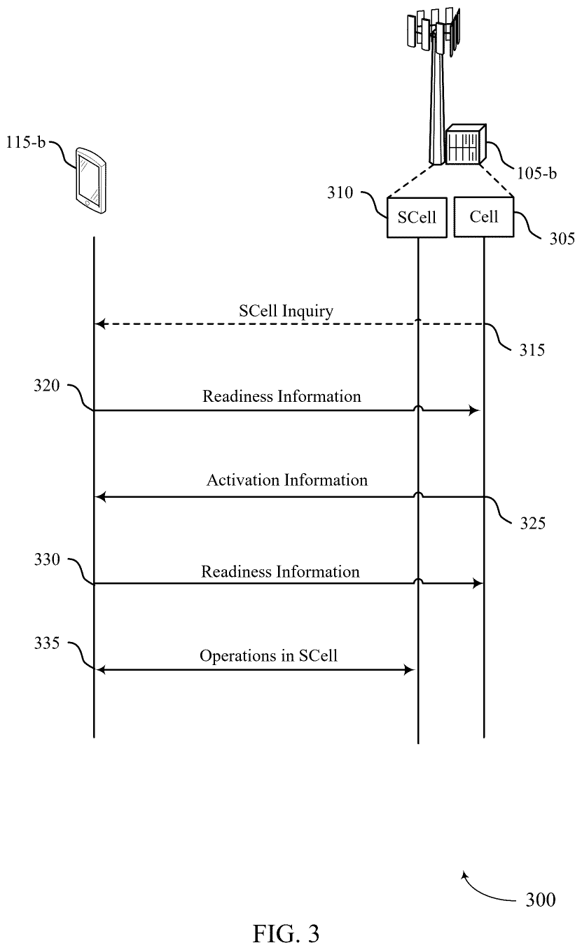

FIG. 3 shows an example of a process flow 300 that supports fast SCell activation in accordance with one or more aspects of the present disclosure. The process flow 300 may implement or be implemented by aspects of a wireless communication system 100 and a wireless communication system 200 described herein. For example, the process flow 300 may be implemented by a UE 115-b and a network entity 105-b, which may be respective examples of a UE 115 and a network entity 105 described herein. The network entity 105-b may support one or more cells, such as a cell 305, which may be an example of a PCell or SCell, and a SCell 310. Additionally, or alternatively, the cell 305 and the SCell 310 may be supported by more than one network entity 105.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices.

At 315, the network entity 105-b may transmit, and the UE 115-b may receive one or more signals that function as an SCell inquiry. The SCell inquiry may include information of one or more candidate SCell configurations (e.g., a pre-configuration). Additionally, or alternatively, the SCell inquiry may include configuration information for the at least one SCell (e.g., SCell 310). The SCell inquiry may be a part of an RRC reconfiguration procedure and may be in the form of SCell addition signaling. In some cases, the SCell inquiry may include information such as whether each SCell is a PUCCH SCell, a downlink SCell, etc.

At 320, the UE 115-b may transmit readiness information that includes a second indication of a time duration after which the network entity will be in the ready state for one or more operations in the at least one SCell, and the time duration is with respect to a timing of activation information (e.g., an activation command). Thus, the time duration may indicate a time duration value that is indicative of when the UE 115-b will be in the ready state after receiving an activation command for the SCell. The readiness information transmitted at 320 may be in the form of a UE capability message. The readiness information may include a respective time duration for each SCell of multiple SCells. The readiness information may include respective time durations for each CC of multiple CCs, each CC group of multiple CC groups, a respective time duration for each FSPC, each band, each band combination, each band of a band combination, each downlink feature set, each uplink feature set, each frequency range (e.g., FR1 or FR2), each duplexing mode or duplexing configuration of a slot (e.g., FDD, TDD, subband full duplex), or any combination thereof. The time duration(s) may be based on whether the SCell is known or unknown, whether the SCell is in a same TAG of a previously activated SCell, whether the SCell is a primary cell or PUCCH cell of a PUCCH group, or any combination thereof. The UE capability message may indicate a quantity of component carriers to which the second indication (e.g., the time duration) is appliable.

In some examples, the UE 115-b performs a multiplexing procedure to multiplex the readiness information with second information of a second transmission that at least partially overlaps with a resource configured for transmission of the readiness information. The readiness information may be multiplexed based on a type of the second information of the second transmission, a resource allocation duration of the second transmission, or a combination thereof. Additionally, or alternatively, the readiness information is multiplexed based on an instruction received from the network entity 105-b and/or a priority associated with the readiness information or a priority associated with the second transmission. The priorities (e.g., priority levels) may be PHY-layer priority levels. The priority level of the readiness information may be assigned a higher priority than other transmissions. In some cases, the UE 115-b may transmit a UE capability message indicating that the UE 115-b supports transmission of readiness information for SCells, and the network entity 105-b may transmit an instruction to transmit the readiness information based on the UE capability. In some cases, the readiness information indicates that the UE 115-b is in the ready state for the one or more operations in the at least one SCell (e.g., SCell 310) that is an uplink SCell, a downlink SCell, or both.

At 325, the UE 115-b may receive activation information that indicates one or more multiple SCells (e.g., SCell 310) that are to be activated. The activation may be configured to cause (e.g., may include information that may cause) the UE to transition to the ready state in the one or more multiple SCells. As such, the activation information may cause the UE to transition to the ready state in the one or multiple SCells.

At 330, the UE 115-b may transmit readiness information that includes a first indication that the UE 115-b is in a ready state for one or more operations in at least one SCell indicated via the activation information. The first indication includes a set of bits indicating whether the UE 115-b is in the ready state for the one or more operations in one or more SCells, including the at least one SCell (e.g., SCell 310). In some cases, the readiness information includes a set of bits, and each bit of the set of bits indicates whether the UE 115-b is in a respective ready state for the one or more operations in each SCell of the one or more SCells. A mapping of each SCell to the set of bits may be based on the SCell identifiers for the SCells. The readiness information may also be indicative of when the UE 115-b is to be in the ready state in the one or more SCells. In some cases, the readiness information is transmitted when the UE 115-b is in the ready state for all of the SCells indicated via the activation information. Additionally, or alternatively, the UE 115-b transmits the readiness information for one or more SCells each time the UE 115-b transitions to the ready state for one or more SCells. In some cases, the UE 115-b updates and retransmits the set of bits when the UE 115-b transitions to the ready state in an SCell.

The readiness information may be transmitted via a PUCCH resources on a PCell, a PUCCH resource on another SCell, or via a MAC-CE message. The MAC-CE message may be carried on a PUSCH resource triggered by the activation information. Additionally, or alternatively, the network entity 105-b may trigger or configure the resource via which the readiness information is transmitted. The readiness information may be transmitted on a cell (e.g., the cell 305) that is in a cell group including the one or more activated SCells (e.g., the SCell 310) in accordance with a rule specifying that readiness information for SCells is to be transmitted to a cell group including the SCells. The readiness information may alternatively be transmitted on a cell of a cell group that does not include the one or more activated SCells. The network entity 105-b may signal the cell (e.g., the cell 305) on which the readiness information is transmitted.

At 335, the UE 115-b may perform, in accordance with one of the first indication or the second indication, the one or more operations in a first SCell (e.g., the SCell 310) of the at least one SCell while the UE 115-b is in the ready state. Such operations may include a layer one RSRP measurement, a CSI measurement/report, receipt of a PDSCH transmission or a PDCCH transmission, transmission of a random access request, or a combination thereof.

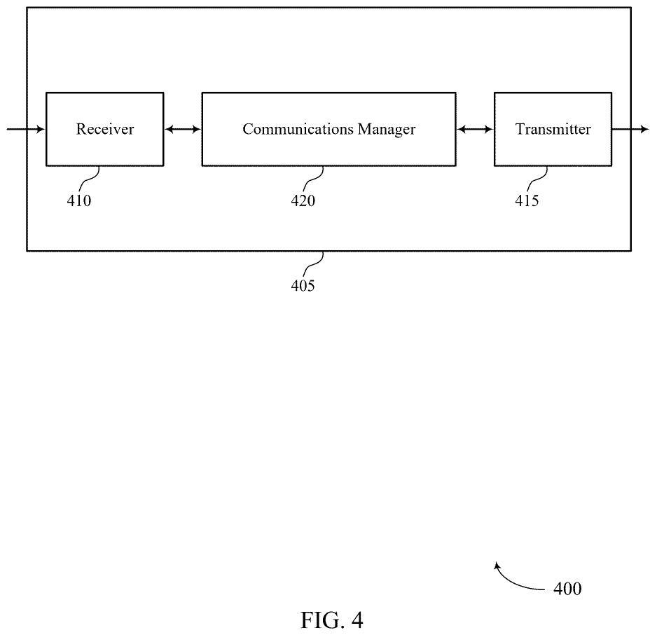

FIG. 4 shows a block diagram 400 of a device 405 that supports fast secondary cell activation in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to fast secondary cell activation). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to fast secondary cell activation). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of fast secondary cell activation as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for transmitting readiness information that includes one of a first indication that the network entity is in a ready state for one or more operations in at least one secondary cell or a second indication of a time duration after which the network entity will be in the ready state for the one or more operations in the at least one secondary cell, where activation information causes the network entity to transition to the ready state, where the first indication includes a set of bits indicating whether the network entity is in the ready state for the one or more operations in one or more secondary cells, including the at least one secondary cell, of the plurality of secondary cells, and where the time duration is with respect to a timing of the activation information. In other words, the activation information may be configured to cause the network entity to transition to the ready state. The communications manager 420 is capable of, configured to, or operable to support a means for performing, in accordance with one of the first indication or the second indication, the one or more operations in a first secondary cell of the at least one secondary cell while the network entity is in the ready state.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for improved throughput by supporting fast SCell activation.

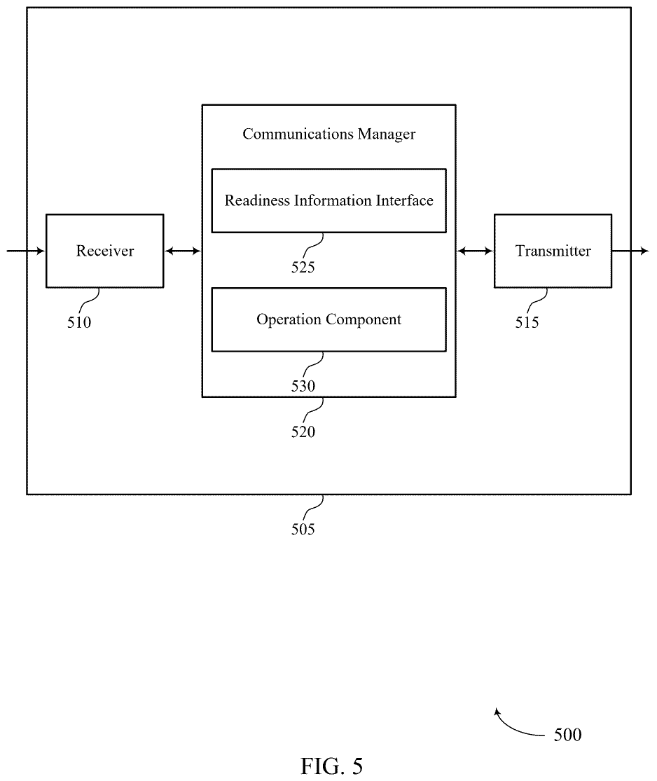

FIG. 5 shows a block diagram 500 of a device 505 that supports fast secondary cell activation in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to fast secondary cell activation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to fast secondary cell activation). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of fast secondary cell activation as described herein. For example, the communications manager 520 may include a readiness information interface 525 an operation component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The readiness information interface 525 is capable of, configured to, or operable to support a means for transmitting readiness information that includes one of a first indication that the network entity is in a ready state for one or more operations in at least one secondary cell or a second indication of a time duration after which the network entity will be in the ready state for the one or more operations in the at least one secondary cell, where activation information causes the network entity to transition to the ready state, where the first indication includes a set of bits indicating whether the network entity is in the ready state for the one or more operations in one or more secondary cells, including the at least one secondary cell, of the plurality of secondary cells, and where the time duration is with respect to a timing of the activation information. The operation component 530 is capable of, configured to, or operable to support a means for performing, in accordance with one of the first indication or the second indication, the one or more operations in a first secondary cell of the at least one secondary cell while the network entity is in the ready state.

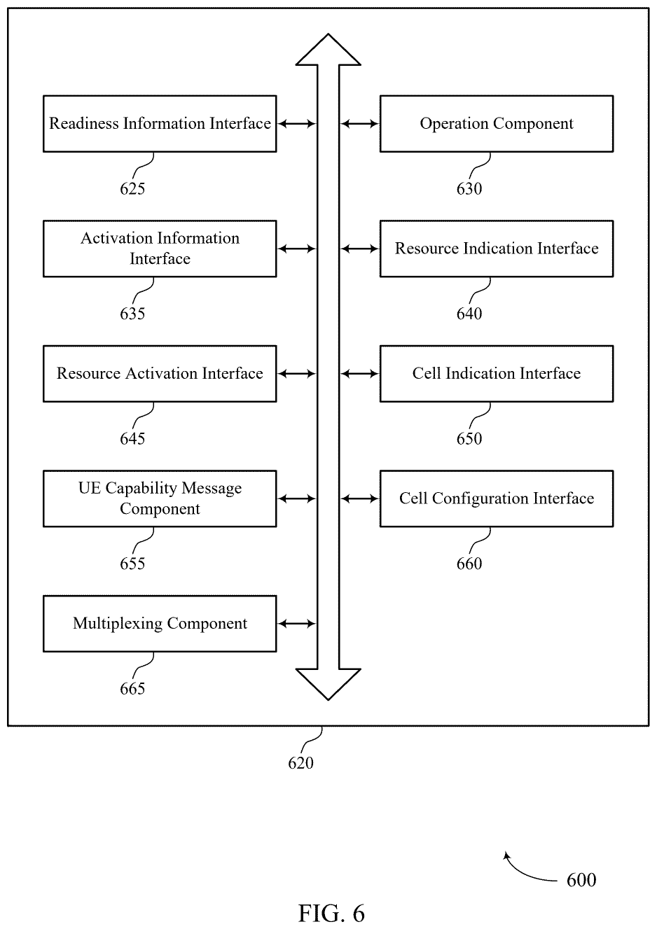

FIG. 6 shows a block diagram 600 of a communications manager 620 that supports fast secondary cell activation in accordance with one or more aspects of the present disclosure. The communications manager 620 may be an example of aspects of a communications manager 420, a communications manager 520, or both, as described herein. The communications manager 620, or various components thereof, may be an example of means for performing various aspects of fast secondary cell activation as described herein. For example, the communications manager 620 may include a readiness information interface 625, an operation component 630, an activation information interface 635, a resource indication interface 640, a resource activation interface 645, a cell indication interface 650, a UE capability message component 655, a cell configuration interface 660, a multiplexing component 665, or any combination thereof. Each of these components, or components or subcomponents thereof (e.g., one or more processors, one or more memories), may communicate, directly or indirectly, with one another (e.g., via one or more buses).

The readiness information interface 625 is capable of, configured to, or operable to support a means for transmitting readiness information that includes one of a first indication that the network entity is in a ready state for one or more operations in at least one secondary cell or a second indication of a time duration after which the network entity will be in the ready state for the one or more operations in the at least one secondary cell, where activation information causes the network entity to transition to the ready state, where the first indication includes a set of bits indicating whether the network entity is in the ready state for the one or more operations in one or more secondary cells, including the at least one secondary cell, of the plurality of secondary cells, and where the time duration is with respect to a timing of the activation information. The operation component 630 is capable of, configured to, or operable to support a means for performing, in accordance with one of the first indication or the second indication, the one or more operations in a first secondary cell of the at least one secondary cell while the network entity is in the ready state.

In some examples, the activation information interface 635 is capable of, configured to, or operable to support a means for receiving the activation information for the at least one secondary cell, where the readiness information includes the first indication, and where, transmitting the readiness information including the first indication includes transmitting the readiness information including the first indication in response to receipt of the activation information.

In some examples, the activation information interface 635 is capable of, configured to, or operable to support a means for receiving the activation information that indicates a plurality of secondary cells, where the readiness information includes a set of bits, and where each bit of the set of bits indicates whether the network entity is in a respective ready state for the one or more operations in each secondary cell of the plurality of secondary cells.

In some examples, the readiness information is indicative of when the network entity is in the ready state for each secondary cell of the plurality of secondary cells.

In some examples, a mapping of each secondary cell of the plurality of secondary cells to each bit of the set of bits is based on respective secondary cell identifiers that correspond to the plurality of secondary cells.

In some examples, the activation information interface 635 is capable of, configured to, or operable to support a means for receiving the activation information that indicates a plurality of secondary cells, and where transmitting the readiness information including the first indication includes transmitting the readiness information including the first indication when the network entity is in the ready state for the one or more operations in the plurality of secondary cells.

In some examples, the activation information interface 635 is capable of, configured to, or operable to support a means for receiving the activation information that indicates a plurality of secondary cells, and where transmitting the readiness information including the second indication includes transmitting the readiness information including the second indication that indicates a time at which the network entity is to be in the ready state for the one or more operations in the plurality of secondary cells.

In some examples, the activation information interface 635 is capable of, configured to, or operable to support a means for receiving the activation information that indicates a plurality of secondary cells, where transmitting the readiness information including the first indication includes transmitting the readiness information including the first indication each time the network entity is in a respective ready state for the one or more operations in one or more secondary cells of the plurality of secondary cells.

In some examples, the readiness information indicates the one or more secondary cells of the plurality of secondary cells for which the network entity is in the respective ready state.

In some examples, the readiness information includes a set of bits, where each bit of the set of bits indicates whether the network entity is in the respective ready state for the one or more operations in each secondary cell of the plurality of secondary cells, where the method further includes updating the set of bits and retransmitting the readiness information including the updated set of bits when the network entity transitions to the respective ready state for the one or more operations in the one or more secondary cells of the plurality of secondary cells.

In some examples, to support transmitting the readiness information, the readiness information interface 625 is capable of, configured to, or operable to support a means for transmitting the readiness information via a first physical uplink control channel resource on a primary cell, via a second physical uplink control channel resource on a cell for which physically uplink control channel resources are configured or activated, or via a medium access control layer control element message.

In some examples, the cell is a previously activated secondary cell.

In some examples, the resource indication interface 640 is capable of, configured to, or operable to support a means for receiving a resource indication that is indicative of a resource via which the readiness information is to be transmitted, where transmitting the readiness information includes transmitting the readiness information via the resource.

In some examples, the resource is a physical uplink shared channel resource triggered by the activation information or a physical uplink control channel resource.

In some examples, the resource activation interface 645 is capable of, configured to, or operable to support a means for receiving a signal that activates a physical uplink shared channel resource, where transmitting the readiness information includes transmitting the readiness information via a medium access control layer control element message in the physical uplink shared channel resource.

In some examples, to support transmitting the readiness information, the readiness information interface 625 is capable of, configured to, or operable to support a means for transmitting the readiness information in a cell of a secondary cell group including the at least one secondary cell in accordance with a rule that specifies that readiness information for secondary cells is to be transmitted to a cell group including the secondary cells.

In some examples, to support transmitting the readiness information, the readiness information interface 625 is capable of, configured to, or operable to support a means for transmitting the readiness information in a primary secondary cell of a secondary cell group including the at least one secondary cell.

In some examples, to support transmitting the readiness information, the readiness information interface 625 is capable of, configured to, or operable to support a means for transmitting the readiness information in a previously activated secondary cell of a secondary cell group including the at least one secondary cell.

In some examples, to support transmitting the readiness information, the readiness information interface 625 is capable of, configured to, or operable to support a means for transmitting the readiness information in a primary cell in a cell group that includes one or more secondary cells different from the at least one secondary cell.

In some examples, the cell indication interface 650 is capable of, configured to, or operable to support a means for receiving a cell indication that is indicative of a cell in a cell group that includes one or more secondary cells different from the at least one secondary cell, where transmitting the readiness information includes transmitting the readiness information in the cell.

In some examples, the activation information interface 635 is capable of, configured to, or operable to support a means for receiving the activation information for the at least one secondary cell, where the readiness information includes the second indication, and where transmitting the readiness information including the second indication includes transmitting the readiness information including the second indication before receipt of the activation information.

In some examples, to support transmitting the readiness information, the UE capability message component 655 is capable of, configured to, or operable to support a means for transmitting a UE capability message including the readiness information.

In some examples, the readiness information includes a respective time duration for each secondary cell of a plurality secondary cells.

In some examples, the readiness information includes a first respective time duration for each component carrier of a set of multiple component carriers. In some examples, a second respective time duration for each component carrier group of a set of multiple component carrier groups.

In some examples, the readiness information includes a respective time duration for each feature set per carrier (FSPC), each band, each band combination, each band of a band combination, each downlink feature set, each uplink feature set, each frequency range, each duplexing mode, or a combination thereof.

In some examples, the time duration is based on whether a secondary cell of the at least one secondary cell is a known cell or an unknown cell, whether the at least one secondary cell is in a same timing advance group (TAG) as a previously activated secondary cell, whether the secondary cell is a primary cell of a secondary physical uplink control channel group, or a combination thereof.

In some examples, the UE capability message indicates a quantity of component carriers to which the second indication is applicable.

In some examples, the cell configuration interface 660 is capable of, configured to, or operable to support a means for receiving, prior to receipt of the activation information, information indicative of one or more candidate secondary cell configurations, where the readiness information includes the second indication, and where transmitting the readiness information including the second indication includes transmitting the readiness information including the second indication in response to reception of the information indicative of the one or more candidate secondary cell configurations.

In some examples, the cell configuration interface 660 is capable of, configured to, or operable to support a means for receiving, prior to receipt of the activation information, configuration information for the at least one secondary cell, where the readiness information includes the second indication, and where transmitting the readiness information including the second indication includes transmitting the readiness information including the second indication in response to receipt of the configuration information.

In some examples, the cell configuration interface 660 is capable of, configured to, or operable to support a means for receiving, prior to receipt of the activation information and during a radio resource control reconfiguration procedure, configuration information for the at least one secondary cell, where the readiness information including the second indication, and where transmitting the readiness information including the second indication includes transmitting the readiness information including the second indication in response to receipt of the configuration information.

In some examples, to support receiving the configuration information, the cell configuration interface 660 is capable of, configured to, or operable to support a means for receiving the configuration information in a secondary cell addition message.

In some examples, the configuration information indicates whether a secondary cell of the at least one secondary cell is a physical uplink control channel secondary cell or a downlink secondary cell.

In some examples, the multiplexing component 665 is capable of, configured to, or operable to support a means for performing a multiplexing procedure, where performing the multiplexing procedure includes multiplexing the readiness information with second information of a second transmission that at least partially overlaps with a resource configured for transmission of the readiness information.

In some examples, to support performing the multiplexing procedure, the multiplexing component 665 is capable of, configured to, or operable to support a means for multiplexing the readiness information based on a type of the second information of the second transmission, a resource allocation duration of the second transmission, or a combination thereof.

In some examples, the multiplexing component 665 is capable of, configured to, or operable to support a means for receiving an instruction to multiplex the readiness information, where performing the multiplexing procedure includes multiplexing the readiness information in accordance with the instruction.

In some examples, a first resource configured for the readiness information at least partially overlaps with a second resource configured for a second transmission, and where transmitting the readiness information includes transmitting the readiness information based on a first priority level associated with the readiness information and a second priority level associated with the second transmission.

In some examples, the first priority level and the second priority level include physical (PHY) layer priority levels.

In some examples, the first priority level is a higher priority level than the second priority level.

In some examples, the UE capability message component 655 is capable of, configured to, or operable to support a means for transmitting a UE capability message that indicates that the network entity supports transmission of the readiness information.

In some examples, the readiness information interface 625 is capable of, configured to, or operable to support a means for receiving, in response to the UE capability message, an instruction to transmit the readiness information, where transmitting the readiness information includes transmitting the readiness information in accordance with the instruction.

In some examples, the readiness information indicates that the network entity is in the ready state for the one or more operations in the at least one secondary cell including one or more first secondary cells configured for uplink communications, one or more second secondary cells configured for downlink communications, or both.

In some examples, the one or more operations include a layer one reference signal received power measurement, a channel state information measurement, receipt of a physical downlink shared channel or a physical downlink control channel, transmission of a random access request, or a combination thereof.

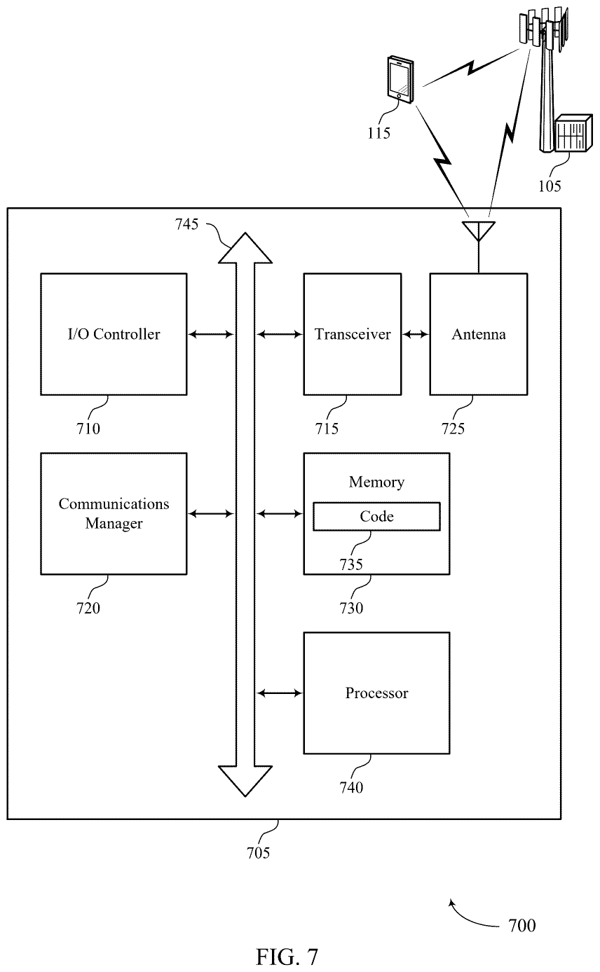

FIG. 7 shows a diagram of a system 700 including a device 705 that supports fast secondary cell activation in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting fast secondary cell activation). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

For example, the communications manager 720 is capable of, configured to, or operable to support a means for transmitting readiness information that includes one of a first indication that the network entity is in a ready state for one or more operations in at least one secondary cell or a second indication of a time duration after which the network entity will be in the ready state for the one or more operations in the at least one secondary cell, where activation information causes the network entity to transition to the ready state, where the first indication includes a set of bits indicating whether the network entity is in the ready state for the one or more operations in one or more secondary cells, including the at least one secondary cell, of the plurality of secondary cells, and where the time duration is with respect to a timing of the activation information. The communications manager 720 is capable of, configured to, or operable to support a means for performing, in accordance with one of the first indication or the second indication, the one or more operations in a first secondary cell of the at least one secondary cell while the network entity is in the ready state.

By including or configuring the communications manager 720 in accordance with examples as described herein, the device 705 may support techniques for improved throughput by supporting fast SCell activation.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of fast secondary cell activation as described herein, or the at least one processor 740 and the at least one memory 730 may be otherwise configured to, individually or collectively, perform or support such operations.

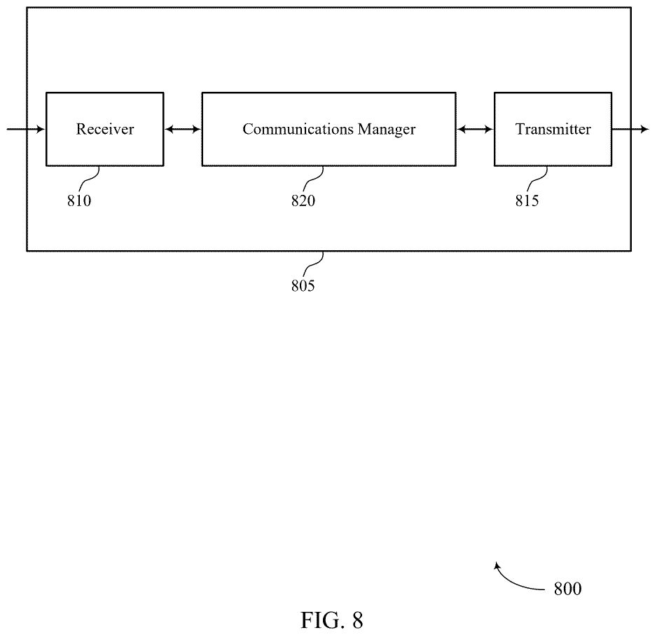

FIG. 8 shows a block diagram 800 of a device 805 that supports fast secondary cell activation in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of fast secondary cell activation as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for receiving readiness information that includes one of a first indication that a second network entity is in a ready state for one or more operations in at least one secondary cell or a second indication of a time duration after which the second network entity will be in the ready state for the one or more operations in the at least one secondary cell, where activation information causes the second network entity to transition to the ready state, where the first indication includes a set of bits indicating whether the network entity is in the ready state for the one or more operations in one or more secondary cells, including the at least one secondary cell, of the plurality of secondary cells, and where the time duration is with respect to a timing of the activation information. The communications manager 820 is capable of, configured to, or operable to support a means for participating, in accordance with one of the first indication or the second indication, in communication of one or more signals associated with the one or more operations in a first secondary cell of the at least one secondary cell while the second network entity is in the ready state.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for improved throughput by supporting fast SCell activation.

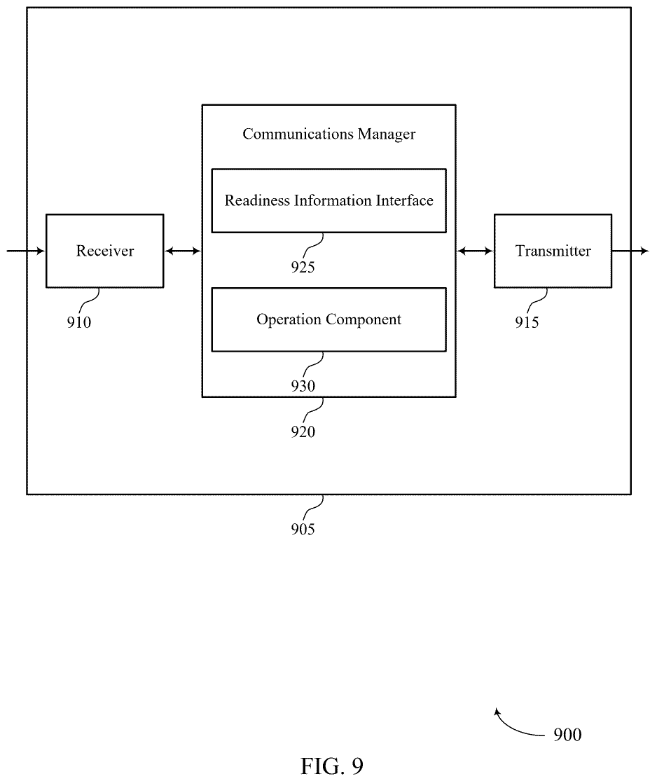

FIG. 9 shows a block diagram 900 of a device 905 that supports fast secondary cell activation in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of fast secondary cell activation as described herein. For example, the communications manager 920 may include a readiness information interface 925 an operation component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The readiness information interface 925 is capable of, configured to, or operable to support a means for receiving readiness information that includes one of a first indication that a second network entity is in a ready state for one or more operations in at least one secondary cell or a second indication of a time duration after which the second network entity will be in the ready state for the one or more operations in the at least one secondary cell, where activation information causes the second network entity to transition to the ready state, where the first indication includes a set of bits indicating whether the network entity is in the ready state for the one or more operations in one or more secondary cells, including the at least one secondary cell, of the plurality of secondary cells, and where the time duration is with respect to a timing of the activation information. The operation component 930 is capable of, configured to, or operable to support a means for participating, in accordance with one of the first indication or the second indication, in communication of one or more signals associated with the one or more operations in a first secondary cell of the at least one secondary cell while the second network entity is in the ready state.

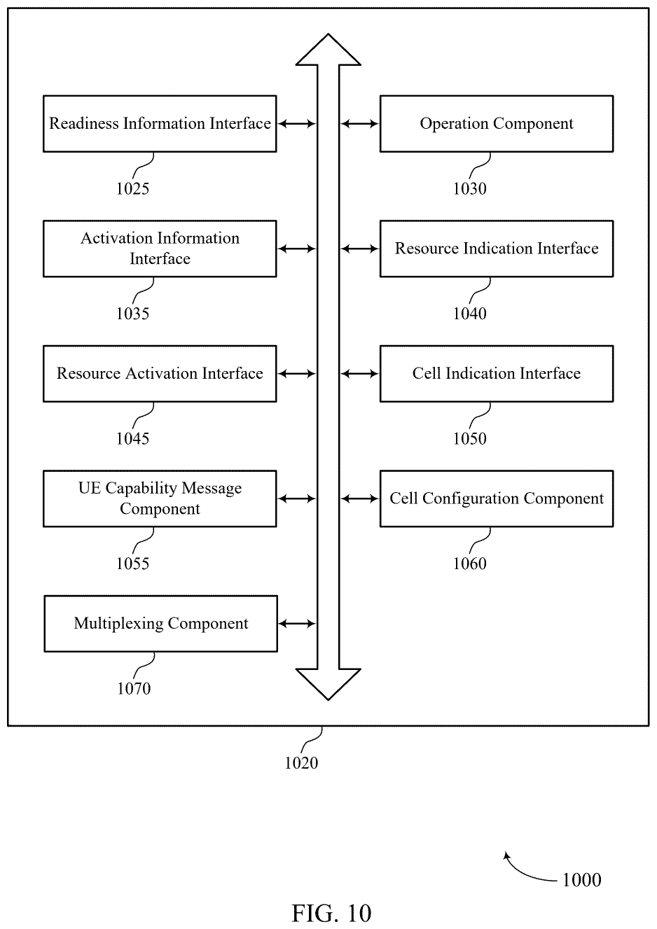

FIG. 10 shows a block diagram 1000 of a communications manager 1020 that supports fast secondary cell activation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of fast secondary cell activation as described herein. For example, the communications manager 1020 may include a readiness information interface 1025, an operation component 1030, an activation information interface 1035, a resource indication interface 1040, a resource activation interface 1045, a cell indication interface 1050, a UE capability message component 1055, a cell configuration component 1060, a multiplexing component 1070, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The readiness information interface 1025 is capable of, configured to, or operable to support a means for receiving readiness information that includes one of a first indication that a second network entity is in a ready state for one or more operations in at least one secondary cell or a second indication of a time duration after which the second network entity will be in the ready state for the one or more operations in the at least one secondary cell, where activation information causes the second network entity to transition to the ready state, where the first indication includes a set of bits indicating whether the network entity is in the ready state for the one or more operations in one or more secondary cells, including the at least one secondary cell, of the plurality of secondary cells, and where the time duration is with respect to a timing of the activation information. The operation component 1030 is capable of, configured to, or operable to support a means for participating, in accordance with one of the first indication or the second indication, in communication of one or more signals associated with the one or more operations in a first secondary cell of the at least one secondary cell while the second network entity is in the ready state.

In some examples, the activation information interface 1035 is capable of, configured to, or operable to support a means for transmitting the activation information for the at least one secondary cell, where the readiness information includes the first indication, and where receiving the readiness information including the first indication includes receiving the readiness information including the first indication in response to transmission of the activation information.

In some examples, the activation information interface 1035 is capable of, configured to, or operable to support a means for transmitting the activation information that indicates a plurality of secondary cells, where the readiness information includes a set of bits, and where each bit of the set of bits indicates whether the second network entity is in a respective ready state for the one or more operations in each secondary cell of the plurality of secondary cells.

In some examples, the readiness information is indicative of when the second network entity is in the ready state for each secondary cell of the plurality of secondary cells.

In some examples, a mapping of each secondary cell of the plurality of secondary cells to each bit of the set of bits is based on respective secondary cell identifiers that correspond to the plurality of secondary cells.

In some examples, the activation information interface 1035 is capable of, configured to, or operable to support a means for transmitting the activation information that indicates a plurality of secondary cells, and where receiving the readiness information including the first indication includes receiving the readiness information including the first indication when the second network entity is in the ready state for the one or more operations in the plurality of secondary cells.

In some examples, the activation information interface 1035 is capable of, configured to, or operable to support a means for transmitting the activation information that indicates a plurality of secondary cells, and where receiving the readiness information includes receiving the readiness information including the second indication that indicates a time at which the second network entity is to be in the ready state for the one or more operations in the plurality of secondary cells.

In some examples, the activation information interface 1035 is capable of, configured to, or operable to support a means for transmitting the activation information that indicates a plurality of secondary cells, and where receiving the readiness information including the first indication includes receiving the readiness information including the first indication each time the second network entity is in a respective ready state for the one or more operations in one or more secondary cells of the plurality of secondary cells.

In some examples, the readiness information indicates the one or more secondary cells of the plurality of secondary cells for which the second network entity is in the respective ready state.

In some examples, to support method, the readiness information interface 1025 is capable of, configured to, or operable to support a means for receiving one or more retransmissions of the readiness information that includes the set of bits that is updated when the second network entity transitions to the respective ready state for the one or more operations in the one or more secondary cells of the plurality of secondary cells.

In some examples, to support receiving the readiness information, the readiness information interface 1025 is capable of, configured to, or operable to support a means for receiving the readiness information via a first physical uplink control channel resource on a primary cell, via a second physical uplink control channel resource on a cell for which physically uplink control channel resources are configured or activated, or via a medium access control layer control element message.

In some examples, the cell is a previously activated secondary cell.

In some examples, the resource indication interface 1040 is capable of, configured to, or operable to support a means for transmitting a resource indication that is indicative of a resource via which the readiness information is to be transmitted by the second network entity, where receiving readiness information includes receiving the readiness information via the resource.

In some examples, the resource is a physical uplink shared channel resource triggered by the activation information or a physical uplink control channel resource.

In some examples, the resource activation interface 1045 is capable of, configured to, or operable to support a means for transmitting a signal that activates a physical uplink shared channel resource, where receiving the readiness information includes receiving the readiness information via a medium access control layer control element message in the physical uplink shared channel resource.

In some examples, to support receiving the readiness information, the readiness information interface 1025 is capable of, configured to, or operable to support a means for receiving the readiness information in a primary secondary cell of a secondary cell group including the at least one secondary cell(

In some examples, to support receiving the readiness information, the readiness information interface 1025 is capable of, configured to, or operable to support a means for receiving the readiness information in a primary secondary cell of a secondary cell group including the at least one secondary cell.

In some examples, to support receiving the readiness information, the readiness information interface 1025 is capable of, configured to, or operable to support a means for receiving the readiness information in a previously activated secondary cell of a secondary cell group including the at least one secondary cell.

In some examples, to support receiving the readiness information, the readiness information interface 1025 is capable of, configured to, or operable to support a means for receiving the readiness information in a primary cell in a cell group that includes one or more secondary cells different from the at least one secondary cell.

In some examples, the cell indication interface 1050 is capable of, configured to, or operable to support a means for transmitting a cell indication that is indicative of a cell in a cell group that includes one or more secondary cells different from the at least one secondary cell, where receiving the readiness information includes receiving the readiness information in the cell.

In some examples, the activation information interface 1035 is capable of, configured to, or operable to support a means for transmitting the activation information for the at least one secondary cell, where the readiness information includes the second indication, and where receiving the readiness information including the second indication includes receiving the readiness information including the second indication when the readiness information is received before transmission of the activation information.

In some examples, to support receiving the readiness information, the UE capability message component 1055 is capable of, configured to, or operable to support a means for receiving a UE capability message including the readiness information.

In some examples, the readiness information includes a respective time duration for each secondary cell of a plurality secondary cells.

In some examples, a respective first time duration for each component carrier of a set of multiple component carriers. In some examples, a respective second time duration for each component carrier group of a set of multiple component carrier groups.

In some examples, the readiness information includes a respective time duration for each feature set per carrier (FSPC), each band, each band combination, each band of a band combination, each downlink feature set, each uplink feature set, each frequency range, each duplexing mode, or a combination thereof.

In some examples, the time duration is based on whether a secondary cell of the at least one secondary cell is a known cell or an unknown cell, whether the at least one secondary cell is in a same timing advance group (TAG) as a previously activated secondary cell, whether the secondary cell is a primary cell of a secondary physical uplink control channel group, or a combination thereof.

In some examples, the UE capability message indicates a quantity of component carriers to which the second indication is applicable.

In some examples, the cell configuration component 1060 is capable of, configured to, or operable to support a means for transmitting, prior to transmission of the activation information, information indicative of one or more candidate secondary cell configurations, where the readiness information includes the second indication, and where receiving the readiness information including the second indication includes receiving the readiness information that includes the second indication in response to transmission of the information indicative of the one or more candidate secondary cell configurations.

In some examples, the cell configuration component 1060 is capable of, configured to, or operable to support a means for transmitting, prior to transmission of the activation information and during a radio resource control reconfiguration procedure, configuration information for the at least one secondary cell, where the readiness information includes the second indication, and where receiving the readiness information including the second indication includes receiving the readiness information including the second indication in response to transmission of the configuration information.

In some examples, to support transmitting the configuration information, the cell configuration component 1060 is capable of, configured to, or operable to support a means for transmitting the configuration information in a secondary cell addition message.

In some examples, the configuration information indicates whether a secondary cell of the at least one secondary cell is a physical uplink control channel secondary cell or a downlink secondary cell.

In some examples, to support receiving the readiness information, the readiness information interface 1025 is capable of, configured to, or operable to support a means for receiving the readiness information that is multiplexed with second information of a second transmission that at least partially overlaps with a resource configured for transmission of the readiness information.

In some examples, to support receiving the readiness information that is multiplexed with the second information, the readiness information interface 1025 is capable of, configured to, or operable to support a means for receiving the readiness information that is multiplexed based on a type of the second information of the second transmission, a resource allocation duration of the second transmission, or a combination thereof.

In some examples, the multiplexing component 1070 is capable of, configured to, or operable to support a means for transmitting an instruction to multiplex the readiness information, where receiving the readiness information that is multiplexed with the second information includes receiving the readiness information that is multiplexed in accordance with the instruction.

In some examples, a first resource configured for the readiness information at least partially overlaps with a second resource configured for a second transmission, and where receiving the readiness information includes receiving the readiness information based on a first priority level associated with the readiness information and a second priority level associated with the second transmission.

In some examples, the first priority level and the second priority level include physical (PHY) layer priority levels.

In some examples, the first priority level is a higher priority level than the second priority level.

In some examples, the UE capability message component 1055 is capable of, configured to, or operable to support a means for receiving a UE capability message that indicates that the second network entity supports transmission of the readiness information.

In some examples, the readiness information interface 1025 is capable of, configured to, or operable to support a means for transmitting, in response to the UE capability message, an instruction to transmit the readiness information, where receiving the readiness information includes receiving the readiness information in accordance with the instruction.

In some examples, the readiness information indicates that the second network entity is in the ready state for the one or more operations in the at least one secondary cell including one or more first secondary cells configured for uplink communications, one or more second secondary cells configured for downlink communications, or both.

In some examples, the one or more operations include a layer one reference signal received power measurement, a channel state information measurement, receipt of a physical downlink shared channel or a physical downlink control channel, transmission of a random access request, or a combination thereof.

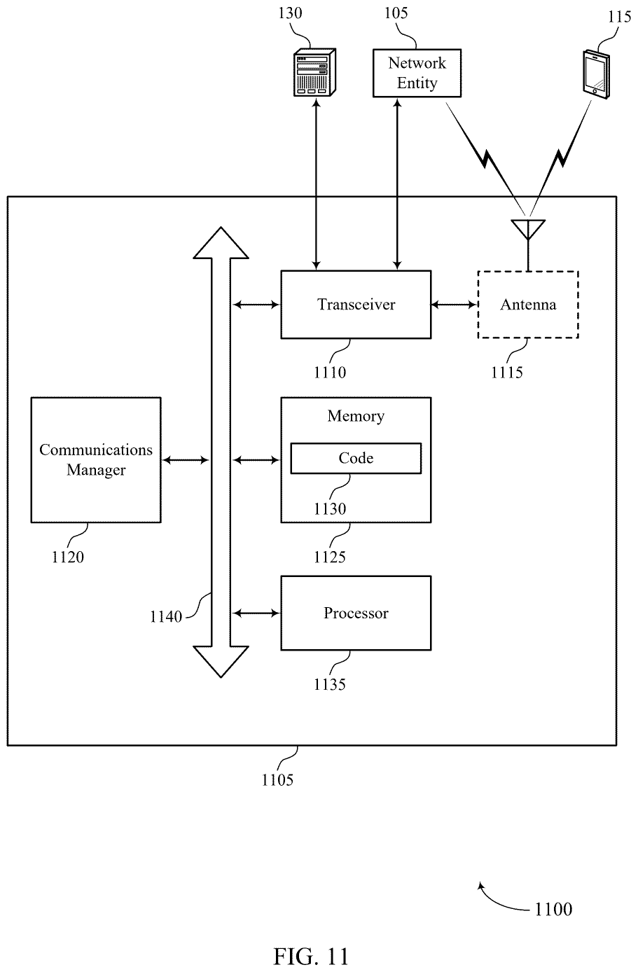

FIG. 11 shows a diagram of a system 1100 including a device 1105 that supports fast secondary cell activation in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting fast secondary cell activation). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

For example, the communications manager 1120 is capable of, configured to, or operable to support a means for receiving readiness information that includes one of a first indication that a second network entity is in a ready state for one or more operations in at least one secondary cell or a second indication of a time duration after which the second network entity will be in the ready state for the one or more operations in the at least one secondary cell, where activation information causes the second network entity to transition to the ready state, where the first indication includes a set of bits indicating whether the network entity is in the ready state for the one or more operations in one or more secondary cells, including the at least one secondary cell, of the plurality of secondary cells, and where the time duration is with respect to a timing of the activation information. The communications manager 1120 is capable of, configured to, or operable to support a means for participating, in accordance with one of the first indication or the second indication, in communication of one or more signals associated with the one or more operations in a first secondary cell of the at least one secondary cell while the second network entity is in the ready state.

By including or configuring the communications manager 1120 in accordance with examples as described herein, the device 1105 may support techniques for improved throughput by supporting fast SCell activation.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of fast secondary cell activation as described herein, or the at least one processor 1135 and the at least one memory 1125 may be otherwise configured to, individually or collectively, perform or support such operations.

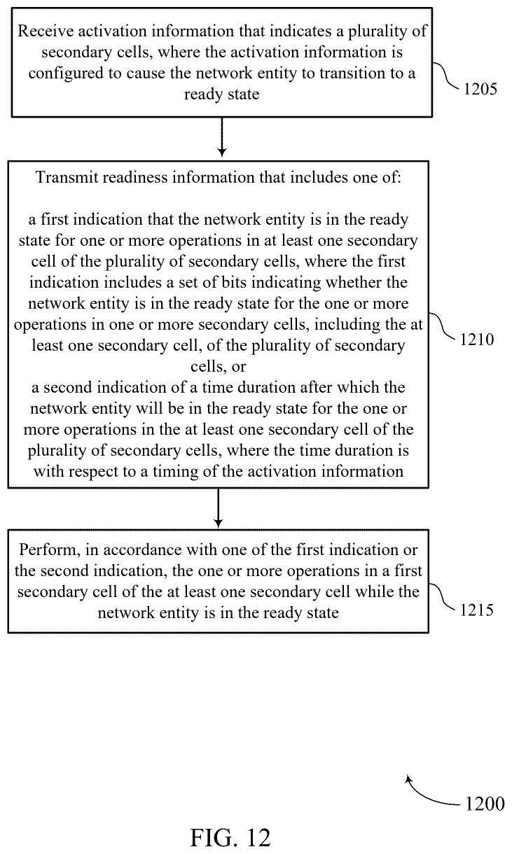

FIG. 12 shows a flowchart illustrating a method 1200 that supports fast secondary cell activation in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving activation information that indicates a plurality of secondary cells, where the activation information causes the second network entity to transition to a ready state. The operations of 1205 may be performed in accordance with examples as disclosed herein. In some examples, aspects of the operations of 1205 may be performed by an activation information interface 635 as described with reference to FIG. 6.

At 1210, the method may include transmitting readiness information that includes one of a first indication that a second network entity is in the ready state for one or more operations in at least one secondary cell of the plurality of secondary cells, wherein the first indication includes a set of bits indicating whether the network entity is in the ready state for the one or more operations in one or more secondary cells, including at least one secondary cell, of the plurality of secondary cells, or a second indication of a time duration after which the second network entity will be in the ready state for the one or more operations in the at least one secondary cell, wherein the time duration is with respect to a timing of the activation information. The operations of 1210 may be performed in accordance with examples as disclosed herein. In some examples, aspects of the operations of 1205 may be performed by a readiness information interface 625 as described with reference to FIG. 6.

At 1215, the method may include performing, in accordance with one of the first indication or the second indication, the one or more operations in a first secondary cell of the at least one secondary cell while the network entity is in the ready state. The operations of 1215 may be performed in accordance with examples as disclosed herein. In some examples, aspects of the operations of 1215 may be performed by an operation component 630 as described with reference to FIG. 6.

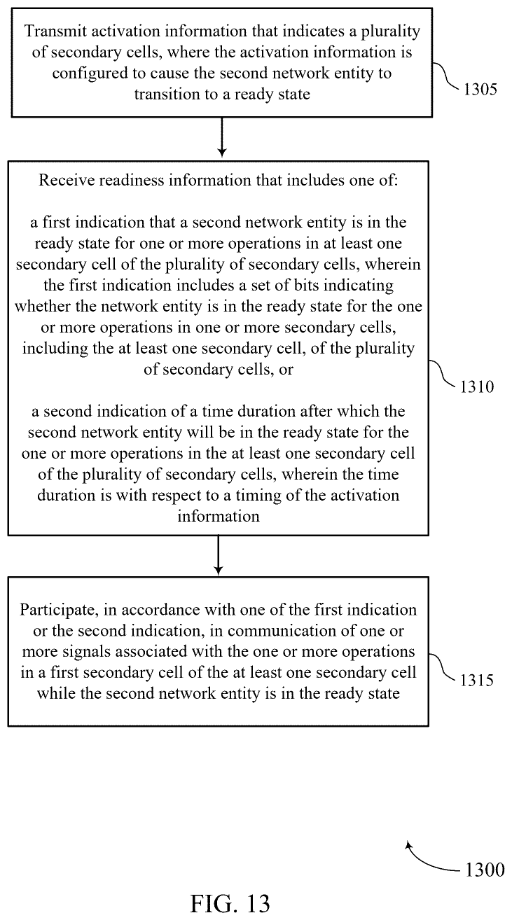

FIG. 13 shows a flowchart illustrating a method 1300 that supports fast secondary cell activation in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include transmitting activation information that indicates a plurality of secondary cells, where the activation information causes the second network entity to transition to a ready state. The operations of 1305 may be performed in accordance with examples as disclosed herein. In some examples, aspects of the operations of 1305 may be performed by an activation information interface 1035 as described with reference to FIG. 10.

At 1310, the method may include receiving readiness information that includes one of a first indication that a second network entity is in the ready state for one or more operations in at least one secondary cell of the plurality of secondary cells, wherein the first indication includes a set of bits indicating whether the network entity is in the ready state for the one or more operations in one or more secondary cells, including at least one secondary cell, of the plurality of secondary cells, or a second indication of a time duration after which the second network entity will be in the ready state for the one or more operations in the at least one secondary cell, wherein the time duration is with respect to a timing of the activation information. The operations of 1310 may be performed in accordance with examples as disclosed herein. In some examples, aspects of the operations of 1310 may be performed by a readiness information interface 1025 as described with reference to FIG. 10.

At 1315, the method may include participating, in accordance with one of the first indication or the second indication, in communication of one or more signals associated with the one or more operations in a first secondary cell of the at least one secondary cell while the second network entity is in the ready state. The operations of 1315 may be performed in accordance with examples as disclosed herein. In some examples, aspects of the operations of 1315 may be performed by an operation component 1030 as described with reference to FIG. 10.

The following provides an overview of aspects of the present disclosure:
Aspect 1: A method of wireless communication performed by a network entity, comprising: transmitting readiness information that includes one of a first indication that the network entity is in a ready state for one or more operations in at least one secondary cell or a second indication of a time duration after which the network entity will be in the ready state for the one or more operations in the at least one secondary cell, wherein activation information is configured to cause the network entity to transition to the ready state, and wherein the time duration is with respect to a timing of the activation information; and performing, in accordance with one of the first indication or the second indication, the one or more operations in a first secondary cell of the at least one secondary cell while the network entity is in the ready state.
Aspect 2: The method of aspect 1, further comprising: receiving the activation information for the at least one secondary cell, wherein the readiness information includes the first indication, and wherein, transmitting the readiness information including the first indication comprises transmitting the readiness information including the first indication in response to receipt of the activation information.
Aspect 3: The method of any of aspects 1 through 2, further comprising: receiving the activation information that indicates a plurality of secondary cells, wherein the readiness information includes a set of bits, and wherein each bit of the set of bits indicates whether the network entity is in a respective ready state for the one or more operations in each secondary cell of the plurality of secondary cells.
Aspect 4: The method of aspect 3, wherein the readiness information is indicative of when the network entity is in the ready state for each cell of the plurality of secondary cells.
Aspect 5: The method of any of aspects 3 through 4, wherein a mapping of each secondary cell of the plurality of secondary cells to each bit of the set of bits is based on respective secondary cell identifiers that correspond to the plurality of secondary cells.
Aspect 6: The method of any of aspects 1 through 5, further comprising: receiving the activation information that indicates a plurality of secondary cells, and wherein transmitting the readiness information including the first indication comprises transmitting the readiness information including the first indication when the network entity is in the ready state for the one or more operations in the plurality of secondary cells.
Aspect 7: The method of any of aspects 1 through 5, further comprising: receiving the activation information that indicates a plurality of secondary cells, and wherein transmitting the readiness information including the second indication comprises transmitting the readiness information including the second indication that indicates a time at which the network entity is to be in the ready state for the one or more operations in the plurality of secondary cells.
Aspect 8: The method of any of aspects 1 through 5, further comprising: receiving the activation information that indicates a plurality of secondary cells, wherein transmitting the readiness information including the first indication comprises transmitting the readiness information including the first indication each time the network entity is in a respective ready state for the one or more operations in one or more secondary cells of the plurality of secondary cells.
Aspect 9: The method of aspect 8, wherein the readiness information indicates the one or more secondary cells of the plurality of secondary cells for which the network entity is in the respective ready state.
Aspect 10: The method of any of aspects 8 through 9, wherein the readiness information includes a set of bits, wherein each bit of the set of bits indicates whether the network entity is in the respective ready state for the one or more operations in each secondary cell of the plurality of secondary cells, wherein the method further comprises updating the set of bits and retransmitting the readiness information including the updated set of bits when the network entity transitions to the respective ready state for the one or more operations in the one or more secondary cells of the plurality of secondary cells.
Aspect 11: The method of any of aspects 1 through 10, wherein transmitting the readiness information comprises: transmitting the readiness information via a first physical uplink control channel resource on a primary cell, via a second physical uplink control channel resource on a cell for which physically uplink control channel resources are configured or activated, or via a medium access control layer control element message.
Aspect 12: The method of aspect 11, wherein the cell is a previously activated secondary cell.
Aspect 13: The method of any of aspects 1 through 12, further comprising: receiving a resource indication that is indicative of a resource via which the readiness information is to be transmitted, wherein transmitting the readiness information comprises transmitting the readiness information via the resource.
Aspect 14: The method of aspect 13, wherein the resource is a physical uplink shared channel resource triggered by the activation information or a physical uplink control channel resource.
Aspect 15: The method of any of aspects 1 through 10, further comprising: receiving a signal that activates a physical uplink shared channel resource, wherein transmitting the readiness information comprises transmitting the readiness information via a medium access control layer control element message in the physical uplink shared channel resource.
Aspect 16: The method of any of aspects 1 through 15, wherein transmitting the readiness information comprises: transmitting the readiness information in a cell of a secondary cell group comprising the at least one secondary cell in accordance with a rule that specifies that readiness information for secondary cells is to be transmitted to a cell group comprising the secondary cells.
Aspect 17: The method of any of aspects 1 through 16, wherein transmitting the readiness information comprises: transmitting the readiness information in a primary secondary cell of a secondary cell group comprising the at least one secondary cell.
Aspect 18: The method of any of aspects 1 through 16, wherein transmitting the readiness information comprises: transmitting the readiness information in a previously activated secondary cell of a secondary cell group comprising the at least one secondary cell.
Aspect 19: The method of any of aspects 1 through 16, wherein transmitting the readiness information comprises: transmitting the readiness information in a primary cell in a cell group that comprises one or more secondary cells different from the at least one secondary cell.
Aspect 20: The method of any of aspects 1 through 16, further comprising: receiving a cell indication that is indicative of a cell in a cell group that comprises one or more secondary cells different from the at least one secondary cell, wherein transmitting the readiness information comprises transmitting the readiness information in the cell.
Aspect 21: The method of aspect 1, further comprising: receiving the activation information for the at least one secondary cell, wherein the readiness information includes the second indication, and wherein transmitting the readiness information including the second indication comprises transmitting the readiness information including the second indication before receipt of the activation information.
Aspect 22: The method aspects 21, wherein transmitting the readiness information comprises: transmitting a UE capability message including the readiness information.
Aspect 23: The method of aspect 22, wherein the readiness information includes a respective time duration for each secondary cell of a plurality secondary cells.
Aspect 24: The method of any of aspects 22 through 23, wherein the readiness information includes a first respective time duration for each component carrier of a plurality of component carriers, or; and a second respective time duration for each component carrier group of a plurality of component carrier groups.
Aspect 25: The method of any of aspects 22 through 24, wherein the readiness information includes a respective time duration for each feature set per carrier (FSPC), each band, each band combination, each band of a band combination, each downlink feature set, each uplink feature set, each frequency range, each duplexing mode, or a combination thereof.
Aspect 26: The method of any of aspects 22 through 25, wherein the time duration is based on whether a secondary cell of the at least one secondary cell is a known cell or an unknown cell, whether the at least one secondary cell is in a same timing advance group (TAG) as a previously activated secondary cell, whether the secondary cell is a primary cell of a secondary physical uplink control channel group, or a combination thereof.
Aspect 27: The method of any of aspects 22 through 26, wherein the UE capability message indicates a quantity of component carriers to which the second indication is applicable.
Aspect 28: The method of any of aspects 21 through 27, further comprising: receiving, prior to receipt of the activation information, information indicative of one or more candidate secondary cell configurations, wherein the readiness information includes the second indication, and wherein transmitting the readiness information including the second indication comprises transmitting the readiness information including the second indication in response to reception of the information indicative of the one or more candidate secondary cell configurations.
Aspect 29: The method of any of aspects 21 through 28, further comprising: receiving, prior to receipt of the activation information, configuration information for the at least one secondary cell, wherein the readiness information includes the second indication, and wherein transmitting the readiness information including the second indication comprises transmitting the readiness information including the second indication in response to receipt of the configuration information.
Aspect 30: The method of any of aspects 21 through 29, further comprising: receiving, prior to receipt of the activation information and during a radio resource control reconfiguration procedure, configuration information for the at least one secondary cell, wherein the readiness information including the second indication, and wherein transmitting the readiness information including the second indication comprises transmitting the readiness information including the second indication in response to receipt of the configuration information.
Aspect 31: The method of aspect 30, wherein receiving the configuration information comprises: receiving the configuration information in a secondary cell addition message.
Aspect 32: The method of any of aspects 30 through 31, wherein the configuration information indicates whether a secondary cell of the at least one secondary cell is a physical uplink control channel secondary cell or a downlink secondary cell.
Aspect 33: The method of any of aspects 1 through 32, further comprising: performing a multiplexing procedure, wherein performing the multiplexing procedure comprises multiplexing the readiness information with second information of a second transmission that at least partially overlaps with a resource configured for transmission of the readiness information.
Aspect 34: The method of aspect 33, wherein performing the multiplexing procedure comprises: multiplexing the readiness information based on a type of the second information of the second transmission, a resource allocation duration of the second transmission, or a combination thereof.
Aspect 35: The method of any of aspects 33 through 34, further comprising: receiving an instruction to multiplex the readiness information, wherein performing the multiplexing procedure comprises multiplexing the readiness information in accordance with the instruction.
Aspect 36: The method of any of aspects 1 through 35, wherein a first resource configured for the readiness information at least partially overlaps with a second resource configured for a second transmission, and wherein transmitting the readiness information comprises transmitting the readiness information based on a first priority level associated with the readiness information and a second priority level associated with the second transmission.
Aspect 37: The method of aspect 36, wherein the first priority level and the second priority level comprise physical (PHY) layer priority levels.
Aspect 38: The method of any of aspects 36 through 37, wherein the first priority level is a higher priority level than the second priority level.
Aspect 39: The method of any of aspects 1 through 38, further comprising: transmitting a UE capability message that indicates that the network entity supports transmission of the readiness information.
Aspect 40: The method of aspect 39, further comprising: receiving, in response to the UE capability message, an instruction to transmit the readiness information, wherein transmitting the readiness information comprises transmitting the readiness information in accordance with the instruction.
Aspect 41: The method of any of aspects 1 through 40, wherein the readiness information indicates that the network entity is in the ready state for the one or more operations in the at least one secondary cell comprising one or more first secondary cells configured for uplink communications, one or more second secondary cells configured for downlink communications, or both.
Aspect 42: The method of any of aspects 1 through 41, wherein the one or more operations comprise a layer one reference signal received power measurement, a channel state information measurement, receipt of a physical downlink shared channel or a physical downlink control channel, transmission of a random access request, or a combination thereof.
Aspect 43: A method of wireless communication performed by a first network entity, comprising: receiving readiness information that includes one of a first indication that a second network entity is in a ready state for one or more operations in at least one secondary cell or a second indication of a time duration after which the second network entity will be in the ready state for the one or more operations in the at least one secondary cell, wherein activation information is configured to cause the second network entity to transition to the ready state, and wherein the time duration is with respect to a timing of the activation information; and participating, in accordance with one of the first indication or the second indication, in communication of one or more signals associated with the one or more operations in a first secondary cell of the at least one secondary cell while the second network entity is in the ready state.
Aspect 44: The method of aspect 43, further comprising: transmitting the activation information for the at least one secondary cell, wherein the readiness information includes the first indication, and wherein receiving the readiness information including the first indication comprises receiving the readiness information including the first indication in response to transmission of the activation information.
Aspect 45: The method of any of aspects 43 through 44, further comprising: transmitting the activation information that indicates a plurality of secondary cells, wherein the readiness information includes a set of bits, and wherein each bit of the set of bits indicates whether the second network entity is in a respective ready state for the one or more operations in each secondary cell of the plurality of secondary cells.
Aspect 46: The method of aspect 45, wherein the readiness information is indicative of when the second network entity is in the ready state for each cell of the plurality of secondary cells.
Aspect 47: The method of any of aspects 45 through 46, wherein a mapping of each secondary cell of the plurality of secondary cells to each bit of the set of bits is based on respective secondary cell identifiers that correspond to the plurality of secondary cells.
Aspect 48: The method of any of aspects 43 through 47, further comprising: transmitting the activation information that indicates a plurality of secondary cells, and wherein receiving the readiness information including the first indication comprises receiving the readiness information including the first indication when the second network entity is in the ready state for the one or more operations in the plurality of secondary cells.
Aspect 49: The method of any of aspects 43 through 47, further comprising: transmitting the activation information that indicates a plurality of secondary cells, and wherein receiving the readiness information comprises receiving the readiness information including the second indication that indicates a time at which the second network entity is to be in the ready state for the one or more operations in the plurality of secondary cells.
Aspect 50: The method of any of aspects 43 through 47, further comprising: transmitting the activation information that indicates a plurality of secondary cells, and wherein receiving the readiness information including the first indication comprises receiving the readiness information including the first indication each time the second network entity is in a respective ready state for the one or more operations in one or more secondary cells of the plurality of secondary cells.
Aspect 51: The method of aspect 50, wherein the readiness information indicates the one or more secondary cells of the plurality of secondary cells for which the second network entity is in the respective ready state.
Aspect 52: The method of any of aspects 50 through 51, wherein the readiness information includes a set of bits, wherein each bit of the set of bits indicates whether the second network entity is in the respective ready state for the one or more operations in each secondary cell of the plurality of secondary cells, and wherein the method comprises: receiving one or more retransmissions of the readiness information that comprises the set of bits that is updated when the second network entity transitions to the respective ready state for the one or more operations in the one or more secondary cells of the plurality of secondary cells.
Aspect 53: The method of any of aspects 43 through 52, wherein receiving the readiness information comprises: receiving the readiness information via a first physical uplink control channel resource on a primary cell, via a second physical uplink control channel resource on a cell for which physically uplink control channel resources are configured or activated, or via a medium access control layer control element message.
Aspect 54: The method of aspect 53, wherein the cell is a previously activated secondary cell.
Aspect 55: The method of any of aspects 43 through 54, further comprising: transmitting a resource indication that is indicative of a resource via which the readiness information is to be transmitted by the second network entity, wherein receiving readiness information comprises receiving the readiness information via the resource.
Aspect 56: The method of aspect 55, wherein the resource is a physical uplink shared channel resource triggered by the activation information or a physical uplink control channel resource.
Aspect 57: The method of any of aspects 43 through 56, further comprising: transmitting a signal that activates a physical uplink shared channel resource, wherein receiving the readiness information comprises receiving the readiness information via a medium access control layer control element message in the physical uplink shared channel resource.
Aspect 58: The method of any of aspects 43 through 57, wherein receiving the readiness information comprises: receiving the readiness information in a cell of a secondary cell group comprising the at least one secondary cell in accordance with a rule that specifies that readiness information for secondary cells is to be transmitted in a cell group comprising the secondary cells.
Aspect 59: The method of any of aspects 43 through 58, wherein receiving the readiness information comprises: receiving the readiness information in a primary secondary cell of a secondary cell group comprising the at least one secondary cell.
Aspect 60: The method of any of aspects 43 through 58, wherein receiving the readiness information comprises: receiving the readiness information in a previously activated secondary cell of a secondary cell group comprising the at least one secondary cell.
Aspect 61: The method of any of aspects 43 through 57, wherein receiving the readiness information comprises: receiving the readiness information in a primary cell in a cell group that comprises one or more secondary cells different from the at least one secondary cell.
Aspect 62: The method of any of aspects 43 through 57, further comprising: transmitting a cell indication that is indicative of a cell in a cell group that comprises one or more secondary cells different from the at least one secondary cell, wherein receiving the readiness information comprises receiving the readiness information in the cell.
Aspect 63: The method of any of aspects 43 through 62, further comprising: transmitting the activation information for the at least one secondary cell, wherein the readiness information includes the second indication, and wherein receiving the readiness information including the second indication comprises receiving the readiness information including the second indication when the readiness information is received before transmission of the activation information.
Aspect 64: The method of any of aspects 43 through 63, wherein receiving the readiness information comprises: receiving a UE capability message including the readiness information.
Aspect 65: The method of aspect 64, wherein the readiness information includes a respective time duration for each secondary cell of a plurality secondary cells.
Aspect 66: The method of any of aspects 64 through 65, wherein the readiness information includes a respective first time duration for each component carrier of a plurality of component carriers, or; and a respective second time duration for each component carrier group of a plurality of component carrier groups.
Aspect 67: The method of any of aspects 64 through 66, wherein the readiness information includes a respective time duration for each feature set per carrier (FSPC), each band, each band combination, each band of a band combination, each downlink feature set, each uplink feature set, each frequency range, each duplexing mode, or a combination thereof.
Aspect 68: The method of any of aspects 64 through 67, wherein the time duration is based on whether a secondary cell of the at least one secondary cell is a known cell or an unknown cell, whether the at least one secondary cell is in a same timing advance group (TAG) as a previously activated secondary cell, whether the secondary cell is a primary cell of a secondary physical uplink control channel group, or a combination thereof.
Aspect 69: The method of any of aspects 64 through 68, wherein the UE capability message indicates a quantity of component carriers to which the second indication is applicable.
Aspect 70: The method of any of aspects 43 through 69, further comprising: transmitting, prior to transmission of the activation information, information indicative of one or more candidate secondary cell configurations, wherein the readiness information includes the second indication, and wherein receiving the readiness information including the second indication comprises receiving the readiness information that includes the second indication in response to transmission of the information indicative of the one or more candidate secondary cell configurations.
Aspect 71: The method of any of aspects 43 through 69, further comprising: transmitting, prior to transmission of the activation information and during a radio resource control reconfiguration procedure, configuration information for the at least one secondary cell, wherein the readiness information includes the second indication, and wherein receiving the readiness information including the second indication comprises receiving the readiness information including the second indication in response to transmission of the configuration information.
Aspect 72: The method of aspect 71, wherein transmitting the configuration information comprises: transmitting the configuration information in a secondary cell addition message.
Aspect 73: The method of any of aspects 71 through 72, wherein the configuration information indicates whether a secondary cell of the at least one secondary cell is a physical uplink control channel secondary cell or a downlink secondary cell.
Aspect 74: The method of any of aspects 43 through 73, wherein receiving the readiness information comprises: receiving the readiness information that is multiplexed with second information of a second transmission that at least partially overlaps with a resource configured for transmission of the readiness information.
Aspect 75: The method of aspect 74, wherein receiving the readiness information that is multiplexed with the second information comprises: receiving the readiness information that is multiplexed based on a type of the second information of the second transmission, a resource allocation duration of the second transmission, or a combination thereof.
Aspect 76: The method of any of aspects 74 through 75, further comprising: transmitting an instruction to multiplex the readiness information, wherein receiving the readiness information that is multiplexed with the second information comprises receiving the readiness information that is multiplexed in accordance with the instruction.
Aspect 77: The method of any of aspects 43 through 76, wherein a first resource configured for the readiness information at least partially overlaps with a second resource configured for a second transmission, and wherein receiving the readiness information comprises receiving the readiness information based on a first priority level associated with the readiness information and a second priority level associated with the second transmission.
Aspect 78: The method of aspect 77, wherein the first priority level and the second priority level comprise physical (PHY) layer priority levels.
Aspect 79: The method of any of aspects 77 through 78, wherein the first priority level is a higher priority level than the second priority level.
Aspect 80: The method of any of aspects 43 through 79, further comprising: receiving a UE capability message that indicates that the second network entity supports transmission of the readiness information.
Aspect 81: The method of aspect 80, further comprising: transmitting, in response to the UE capability message, an instruction to transmit the readiness information, wherein receiving the readiness information comprises receiving the readiness information in accordance with the instruction.
Aspect 82: The method of any of aspects 43 through 81, wherein the readiness information indicates that the second network entity is in the ready state for the one or more operations in the at least one secondary cell comprising one or more first secondary cells configured for uplink communications, one or more second secondary cells configured for downlink communications, or both.
Aspect 83: The method of any of aspects 43 through 82, wherein the one or more operations comprise a layer one reference signal received power measurement, a channel state information measurement, receipt of a physical downlink shared channel or a physical downlink control channel, transmission of a random access request, or a combination thereof.
Aspect 84: A network entity comprising a processing system configured to cause the network entity to perform a method of any of aspects 1 through 42.
Aspect 85: A network entity comprising at least one means for performing a method of any of aspects 1 through 42.
Aspect 86: A non-transitory computer-readable medium having code for wireless communication stored thereon that, when executed by a network entity, causes the network entity to perform a method of any of aspects 1 through 42.
Aspect 87: A non a computer program comprising instructions which, when the program is executed by a computer, cause the computer to carry out the method of any one of aspects 1 through 42.
Aspect 88: A first network entity comprising a processing system configured to cause the first network entity to perform a method of any of aspects 43 through 83.
Aspect 89: A first network entity comprising at least one means for performing a method of any of aspects 43 through 83.
Aspect 90: A non-transitory computer-readable medium having code for wireless communication stored thereon that, when executed by a first network entity, causes the first network entity to perform a method of any of aspects 43 through 83.
Aspect 91: A non a computer program comprising instructions which, when the program is executed by a computer, cause the computer to carry out the method of any one of aspects 43 through 83.

The methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. f, as used herein, the phrase “a set” shall be construed as including the possibility of a set with one member. That is, the phrase “a set” shall be construed in the same manner as “one or more” or “at least one of.” Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items).

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
receive activation information that indicates a plurality of secondary cells, wherein the activation information causes the network entity to transition to a ready state;
transmit readiness information that includes one of:
a first indication that the network entity is in the ready state for one or more operations in at least one secondary cell of the plurality of secondary cells, wherein the first indication includes a set of bits indicating whether the network entity is in the ready state for the one or more operations in one or more secondary cells, including the at least one secondary cell, of the plurality of secondary cells, or
a second indication of a time duration after which the network entity will be in the ready state for the one or more operations in the at least one secondary cell of the plurality of secondary cells, wherein the time duration is with respect to a timing of the activation information; and
perform, in accordance with one of the first indication or the second indication, the one or more operations in a first secondary cell of the at least one secondary cell while the network entity is in the ready state.

2. The network entity of claim 1, wherein each bit of the set of bits indicates whether the network entity is in a respective ready state for the one or more operations in each secondary cell of the plurality of secondary cells.

3. The network entity of claim 2, wherein the readiness information is indicative of when the network entity is in the ready state for each secondary cell of the plurality of secondary cells.

4. The network entity of claim 2, wherein a mapping of each secondary cell of the plurality of secondary cells to each bit of the set of bits is based on respective secondary cell identifiers that correspond to the plurality of secondary cells.

5. The network entity of claim 1, wherein, to transmit the readiness information including the first indication, the processing system is configured to transmit the readiness information including the first indication when the network entity is in the ready state for the one or more operations in the plurality of secondary cells.

6. The network entity of claim 1, wherein, to transmit the readiness information including the second indication, the processing system is configured to transmit the readiness information including the second indication that indicates a time at which the network entity is to be in the ready state for the one or more operations in the plurality of secondary cells.

7. The network entity of claim 1, wherein to transmit the readiness information including the first indication, the processing system is configured to transmit the readiness information including the first indication each time the network entity is in a respective ready state for the one or more operations in one or more secondary cells of the plurality of secondary cells.

8. The network entity of claim 7, wherein the readiness information indicates the one or more secondary cells of the plurality of secondary cells for which the network entity is in the respective ready state.

9. The network entity of claim 7, wherein each bit of the set of bits indicates whether the network entity is in the respective ready state for the one or more operations in each secondary cell of the plurality of secondary cells, wherein the processing system is configured to update the set of bits and retransmit the readiness information including the updated set of bits when the network entity transitions to the respective ready state for the one or more operations in the one or more secondary cells of the plurality of secondary cells.

10. The network entity of claim 1, wherein the readiness information indicates that the network entity is in the ready state for the one or more operations in the at least one secondary cell comprising one or more first secondary cells configured for uplink communications, one or more second secondary cells configured for downlink communications, or both.

11. The network entity of claim 1, wherein, to transmit the readiness information, the processing system is configured to transmit the readiness information via a first physical uplink control channel resource on a primary cell, via a second physical uplink control channel resource on a secondary cell for which physically uplink control channel resources are configured or activated, or via a medium access control layer control element message.

12. The network entity of claim 1, wherein the processing system is configured to:
receive a resource indication that is indicative of a resource via which the readiness information is to be transmitted, wherein, to transmit the readiness information, the processing system is configured to transmit the readiness information via the resource.

13. The network entity of claim 1, wherein the processing system is configured to:
receive a signal that activates a physical uplink shared channel resource, wherein, to transmit the readiness information, the processing system is configured to transmit the readiness information via a medium access control layer control element message in the physical uplink shared channel resource.

14. The network entity of claim 1, wherein, to transmit the readiness information, the processing system is configured to transmit the readiness information in a cell of a secondary cell group comprising the at least one secondary cell in accordance with a rule that specifies that readiness information for secondary cells is to be transmitted to a cell group comprising the secondary cells.

15. The network entity of claim 1, wherein, to transmit the readiness information, the processing system is configured to transmit the readiness information in a primary secondary cell of a secondary cell group comprising the at least one secondary cell.

16. The network entity of claim 1, wherein, to transmit the readiness information, the processing system is configured to transmit the readiness information in a previously activated secondary cell of a secondary cell group comprising the at least one secondary cell.

17. The network entity of claim 1, wherein, to transmit the readiness information, the processing system is configured to transmit the readiness information in a primary cell in a cell group that comprises one or more secondary cells different from the at least one secondary cell.

18. The network entity of claim 1, wherein the processing system is configured to:
receive a cell indication that is indicative of a cell in a cell group that comprises one or more secondary cells different from the at least one secondary cell, wherein, to transmit the readiness information, the processing system is configured to transmit the readiness information in the cell.

19. The network entity of claim 1, wherein the readiness information includes the second indication, and wherein, to transmit the readiness information including the second indication, the processing system is configured to transmit the readiness information including the second indication before receipt of the activation information.

20. The network entity of claim 1, wherein, to transmit the readiness information including the second indication, the processing system is configured to transmit a user equipment (UE) capability message including the readiness information.

21. The network entity of claim 20, wherein the readiness information includes a respective time duration for each secondary cell of a plurality secondary cells.

22. The network entity of claim 20, wherein the readiness information includes:
a first respective time duration for each component carrier of a plurality of component carriers, or
a second respective time duration for each component carrier group of a plurality of component carrier groups.

23. The network entity of claim 20, wherein the readiness information includes a respective time duration for each feature set per carrier (FSPC), each band, each band combination, each band of a band combination, each downlink feature set, each uplink feature set, each frequency range, each duplexing mode, or a combination thereof.

24. The network entity of claim 20, wherein the time duration is based on whether a secondary cell of the at least one secondary cell is a known cell or an unknown cell, whether the at least one secondary cell is in a same timing advance group (TAG) as a previously activated secondary cell, whether the secondary cell is a primary cell of a secondary physical uplink control channel group, or a combination thereof.

25. The network entity of claim 1, wherein the processing system is configured to:
receive, prior to receipt of the activation information, information indicative of one or more candidate secondary cell configurations, wherein the readiness information includes the second indication, and wherein, to transmit the readiness information including the second indication, the processing system is configured to transmit the readiness information including the second indication in response to reception of the information indicative of the one or more candidate secondary cell configurations.

26. The network entity of claim 1, wherein the processing system is configured to:
receive, prior to receipt of the activation information, configuration information for the at least one secondary cell, wherein the readiness information includes the second indication, and wherein, to transmit the readiness information including the second indication, the processing system is configured to transmit the readiness information including the second indication in response to receipt of the configuration information.

27. The network entity of claim 1, wherein the processing system is configured to:
receive, prior to receipt of the activation information and during a radio resource control reconfiguration procedure, configuration information for the at least one secondary cell, wherein the readiness information includes the second indication, and wherein, to transmit the readiness information including the second indication, the processing system is configured to transmit the readiness information including the second indication in response to receipt of the configuration information.

28. The network entity of claim 1, wherein the processing system is configured to:
perform a multiplexing procedure, wherein to perform the multiplexing procedure, the processing system is configured to multiplex the readiness information with second information of a second transmission that at least partially overlaps with a resource configured for transmission of the readiness information.

29. The network entity of claim 1, wherein a first resource configured for the readiness information at least partially overlaps with a second resource configured for a second transmission, and wherein, to transmit the readiness information, the processing system is configured to transmit the readiness information based on a first priority level associated with the readiness information and a second priority level associated with the second transmission.

30. A first network entity for wireless communication, comprising:
a processing system configured to:
transmit activation information that indicates a plurality of secondary cells, wherein the activation information causes a second network entity to transition to a ready state;
receive readiness information that includes one of:
a first indication that the second network entity is in the ready state for one or more operations in at least one secondary cell of the plurality of secondary cells, wherein the first indication includes a set of bits indicating whether the first network entity is in the ready state for the one or more operations in one or more secondary cells, including the at least one secondary cell, of the plurality of secondary cells, or
a second indication of a time duration after which the second network entity will be in the ready state for the one or more operations in the at least one secondary cell of the plurality of secondary cells, wherein the time duration is with respect to a timing of the activation information; and
participate, in accordance with one of the first indication or the second indication, in communication of one or more signals associated with the one or more operations in a first secondary cell of the at least one secondary cell while the second network entity is in the ready state.
